(19) United States
(12) Patent Application Publication
(10) Pub. No.: US 2011/0093317 A1
(43) Pub. Date: Apr. 21, 2011

(54) COMBINATORIAL PORTFOLIO AGGREGATIONS IN ELECTRONIC TRADE

(76) Inventor: Danny Chan, New York, NY (US)

(21) Appl. No.: 12/907,786

(22) Filed: Oct. 19, 2010

Related U.S. Application Data
(63) Continuation-in-part of application No. 12/589,295, filed on Oct. 21, 2009.

(51) Int. Cl. G06Q 30/00

(52) U.S. Cl. 705/14.4; 705/26.3

(57) ABSTRACT

A method for combinatorial portfolio aggregations in electronic trade transactions, in one example embodiment, comprises receiving data associated with an offer for possession of at least one part of an item for a period of time, receiving further data associated with at least one further offer for possession of the at least one part of the item for at least one further period of time, with the time period and the at least one further period of time being non-concurrent, selectively aggregating the offer with the at least one further offer into a portfolio offer for the at least one part of the item, and based on predetermined criteria, determining that the portfolio offer is a winning portfolio offer. The method can further comprise matching the offer to the item based on the data associated with the offer for possession, the item properties, and the item transfer criteria, and selectively aggregating the offer with the at least one further offer into a portfolio offer for the at least one part of the item. The method can further comprise determining whether an escrow amount is required and based on the determination, require a payment of an escrow in order to take possession of the item. The method can further comprise receiving data associated with an offer for possession of at least one part of an item for a period of time, wherein the possession is for demonstration purposes.

### RELATED APPLICATIONS

This Patent Application is a Continuation-In-Part application that claims the priority benefit of U.S. Nonprovisional patent application Ser. No. 12/589,295 filed on Oct. 21, 2009, titled “Combinatorial portfolio aggregations in electronic trade,” which is hereby incorporated by reference in its entirety.

### FIELD

This application relates generally to data processing and, more specifically, to combinatorial portfolio aggregations in electronic trade.

### BACKGROUND

Electronic trade transactions such as online auctions and other types of monetary and non-monetary exchanges have become increasingly popular. A traditional online auction is the process of selling an item to the single highest bidder. At the end of the traditional online auction, the highest bidder becomes the owner of the item. The objective of the traditional online auction is to maximize the amount paid to the seller for the item. However, a potential buyer may only need the item for a certain period of time or only after a certain date. Nevertheless, in order to possess the item for whatever short period of time, the potential buyer is forced to buy the item outright. On the other hand, the seller may only wish to restore the ownership after a period of time or transfer the possession after a certain date or both. The traditional online auction is ill-suited to achieve these goals. Furthermore, the traditional online auction is ill-suited to create the market in which buyers are willing to share in non-concurrent (not occurring at the same time) ownership of the item.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In an example, a computer-implemented method comprises receiving data associated with an offer for potential possession and/or usage of at least one part of an item for a period of time, receiving further data associated with at least one further offer for potential possession and/or usage of the at least one part of the item for at least one further period of time, with the period of time and the at least one further period of time being non-concurrent, selectively aggregating the offer with the at least one further offer into a portfolio offer for the at least one part of the item, and based on predetermined criteria, determining that the portfolio offer is a winning portfolio offer.

In an example, the computer-implemented method further comprises awarding the at least one part of an item to one or more bidders associated with the winning portfolio offer. In an example, the awarding of the at least one part of the item is conditional on the portfolio offer reaching a predetermined reserve price if a predetermined reserve price is set. In an example, the seller or the ownership bidder associated with the offer can eliminate the at least one further offer when the portfolio offer exceeds the predetermined reserve price.

In an example, the predetermined reserve price can be lowered by the seller. In an example, the aggregating continues until a predetermined time limit expires. In an example, the data associated with the offer includes an indication that the offer can be aggregated with the at least one further offer. In an example, the seller can select a minimum bid or the ownership bidder can select a minimum bid amount from all other bidders within his portfolio of bids.

In an example, the period of time and the at least one further period of time can be selected from a group consisting of temporary periods of time and a permanent period of time. In an example, the method further enables a party associated with the permanent period of time to control the aggregation of the portfolio bid. In an example, the permanent period of time starts on a predetermined future date and/or for a predetermined number of days following the transfer of possession. In an example, the item can be automatically selected from at least one listing of a product, the product being a plurality of items similar to the item. In an example, the offer is monetary, non-monetary, or an offer for an exchange of goods and/or services. In an example, the method further comprises informing the parties associated with the offer and the at least one further offer that the acceptance includes the agreement to pay predetermined fines upon defaulting.

In further examples, the above methods steps are stored on a machine-readable medium comprising instructions, which when implemented by one or more processors perform the steps. In yet further examples, subsystems or devices can be adapted to perform the recited steps. Other features, examples, and embodiments are described below.

### BRIEF DESCRIPTION OF DRAWINGS

Example embodiments are illustrated by way of example and not limitation in the figures of the accompanying drawings, in which like references indicate similar elements and in which:

FIG. 1 is a block diagram showing a sample network environment within which systems and methods for combinatorial portfolio aggregations in electronic trade are implemented, in accordance with an example embodiment;

FIG. 2 is a block diagram showing an electronic trade engine, in accordance with an example embodiment;

FIGS. 3-7 are flow charts showing methods for combinatorial portfolio aggregations in electronic trade, in accordance with example embodiments;

FIG. 8 is a diagrammatic representation of an example machine in the form of a computer system within which a set of instructions for causing the machine to perform any one or more of the methodologies discussed herein is executed;

FIG. 9 is the first part of a flow chart showing a method for combinatorial portfolio aggregations in electronic trade using a queue of pipeline offers, in accordance with an example embodiment;

FIG. 10 is the second part of a flow chart showing a method for combinatorial portfolio aggregations in electronic trade using a queue of pipeline offers, in accordance with an example embodiment;

FIG. 11 is a flow chart showing methods for creation of buyer and seller groups, in accordance with an example embodiment; and

FIG. 12 is a flow chart showing a method for combinatorial portfolio aggregations in electronic trade using an escrow, in accordance with an example embodiment;

FIG. 13 is a flow chart showing a method for demonstration of an item, in accordance with an example embodiment.

FIGS. 14 and 15 are flow charts showing a method for combinatorial portfolio aggregations in electronic trade using a docker bidder, in accordance with an example embodiment;

FIG. 16 is a flow chart showing a method for combinatorial portfolio aggregations in electronic trade using a docker bidder, in accordance with an example embodiment;

FIG. 17 is a flow chart showing a method for combinatorial portfolio aggregations in electronic utilizing various interface devices, in accordance with an example embodiment;

FIG. 18 is a flow chart showing a method for combinatorial portfolio aggregations in electronic trade using a docker bidder, in accordance with an example embodiment; and

FIG. 19-21 are flow charts showing a method for combinatorial portfolio aggregations in electronic trade utilizing one or more friends or associates, in accordance with an example embodiment.

### DETAILED DESCRIPTION

Example methods and systems for combinatorial portfolio aggregations in electronic trade are described. In the following description, for purposes of explanation, numerous specific details are set forth in order to provide a thorough understanding of example embodiments. It will be evident, however, to one skilled in the art that the present invention may be practiced without these specific details.

In some example embodiments, methods and systems for combinatorial portfolio aggregations in electronic trade can be utilized to conduct online trades in which buyers bid on one or more periods of time of non-concurrent possession of an item or the non-concurrent possession of one or more parts of the item, wherein the bid may be a portfolio bid of multiple buyers. The item can comprise one or more similar items listed by one or more sellers. The possessions can comprise a period of temporary possession, with the ownership commencing at the conclusion of a transaction, after one or more temporary possessions, or as a delayed ownership. The systems and methods described herein can be utilized in monetary and non-monetary trades.

In a traditional online trade, the trade winner receives complete ownership of the item at the conclusion of the trade. In the case of a trade for lease, the trade winner takes possession of the item and the ownership reverts to the seller at the conclusion of the lease, or the lessee can have an option of buying the item at the end of the lease. Thus, potential buyers compete for the item notwithstanding the fact that they do not need to possess the item simultaneously. The methods and systems for combinatorial portfolio aggregations in electronic trade may permit bidders to bid for possession of the item for respective non-concurrent time periods and at the same time to potentially increase the bid amount by aggregating their respective bids. Thus, for example, one student may bid to acquire a textbook for one semester and another student may bid to acquire the textbook for another semester, and the aggregated bid will include the sum of both bids.

Thus, in some example embodiments, methods and systems for combinatorial portfolio aggregations in electronic trade can permit multiple bidders to bid as a group and to aggregate their individual bids in a group portfolio bid. When the group portfolio bid is declared the winning bid, the group of bidders associated with the winning bid share in the non-concurrent ownership of the item. The ownership of the item is divided between the members of the group according to the time periods or number of days associated with their respective bids. In some example embodiments, one member of the group can be the final owner of the item. In further example embodiments, the ownership of the item will revert to the seller once all temporary possessions by the members of the group expire. In yet further example embodiments, the seller may not specify who the final owner is. In such case, a member of the group can be the final possessor of the item until another transfer of the item is created in a different trade. The criteria of transactions and the responsibilities of the parties are determined by the seller.

In some example embodiments, the seller may offer long-term contracts on when and how to sell an item, to which buyers the item can be sold, and the criteria by which the final owner is selected. Hence, the transaction can be the final sale where the seller no longer owns the item or has the lease and where the seller or a member of the winning portfolio receives the item back after a pre-determined period of time. The highest bidder may not be the winning bidder because the item can be awarded to a portfolio bid rather than to individual bidders. Additionally, the highest bidder may not be the final owner because, for example, the seller reserves the eventual ownership of the item or the bid for the eventual ownership is not the highest bid in the winning portfolio. The item being sold can be of any physical or digital format. The item is not limited to physical items and can include a service.

In some example embodiments, once the trade commences, the bidder that desires to assume the eventual ownership of the item can start a bidding portfolio and then permit other bidders to aggregate their bids with his bid. In some example embodiments, the bidder can provide such permission to aggregate implicitly by entering the date on which he needs to start owning the item or the total number of days before owning the item. Others bidders can join the bidding portfolio by bidding on possession of the item, with the bid remaining in effect until a certain expiration date or for a number of days from the date of the bid. It will be understood that the approaches described herein are not limited to any specific type of trade and can be implemented in any type of transaction.

In some example embodiments, bidders can outbid existing bidders within the same portfolio bid and advance ahead of one or more of the existing bidders in receiving the item, thereby increasing the aggregated bid amount. A bidder not willing to join an existing bidding portfolio can start a new bidding portfolio. In some example embodiments, at the end of the trade, the eventual ownership bidder can eliminate some bids from the portfolio. For example, when the aggregated bid amount is the highest portfolio bid and exceeds the published reserve price, some bids can be eliminated while ensuring that the aggregated bid is still the highest bid. Thus, a bidder can create a new portfolio bid or join multiple other portfolios. Ousted bidders can join multiple other portfolios or start a new portfolio bid at their preferred bid amount and desired time of possession, provided that the trade has not expired.

In some example embodiments, buyers can bid on an item within a portfolio bid by selecting their own reserve price and time by which they wish the transaction to occur. If the time selected by the bidder exceeds the trade's expiration date and the portfolio bid is not the winning bid or no bid wins at all, the seller can choose to repost the item and include the bid in a new portfolio bid for the item. In some example embodiments, the seller can aggregate and transact even though the reserve price is not reached. In such case, the seller may retain the ownership of the item.

In some example embodiments, the buyer can specify a reserve price to own the item without specifying the expiration date of the bid. If more than one buyer bids to own, the ownership bidder can choose to resell to the lower bidders after a certain period of time. For example, in the case of college textbooks, the highest bidder can resell to the lower bidders after 5 months. In some example embodiments, a portfolio bid can be lacking a bidder for the eventual ownership of the item. In such case, the eventual ownership can revert to the seller. Depending on the criteria set for the trade, the seller may select a buyer remaining in possession of the item until a new trade transfers the item to another buyer.

In some example embodiments, the seller may be willing to sell an item after a certain future date. The potential buyers may not be certain whether or not they need the item after this future date. To facilitate the sale process, the seller may offer an option contract in which a potential buyer pays a fee for the right to complete the transaction. In some other example embodiments, the seller may charge a predetermined fine if the buyer defaults and the transaction is not completed according to the option contract.

In some example embodiments, the owner of the item can permit bidders to bid money and at the same time permit sharing and/or giving away the item free of charge for the periods of time with no existing money bidders. In such case, a bidder can bid $0. The transfer of the item may be performed according to the chronological order of bids, with the last bidder in the group remaining in possession of the item until the next bidder or a group of bidders requests the item. According to the example embodiment, a bidder that makes a monetary bid can advance ahead of other $0 bidders or lower monetary bidders if the seller permits.

In some example embodiments, a seller may allow a docker bidder which is the last bidder to possess the item when the item does not revert to the owner and there is no owner bidder. For example, the docker bidder can be determined based on bidders of the portfolio bidding separately to be the docker bidder or to have their highest portfolio bidder determine who is to be the docker bidder. Docker bidders may pay fees and receive fees. The criteria for determining the docker bidder may be set by the seller. In some example embodiments, bidders may bid via multiple types of user interface devices. Hot keys may be utilized to assist bidders in making bids with one or more keys or words.

Traded items may be associated with friends of the seller so that bidders who are friends of the seller or other buyers who conducted business with the seller are notified of their ratings and comments first or exclusive opinions for their friends and common interest associates, in addition to the generally available public ratings. This approach may provide a deeper level of information for the bidder in deciding whether to place a bid and the bid amount. Additionally, a search may be performed based on friends, items, description, and/or item identification.

In some example embodiments, sellers may have multiple options for selling items. Sellers may have an option of selling to one buyer for one price, a group of buyers for another price, to one buyer for an auction price, or to all buyers without a price. Sellers may be able to reach buyers by various means, such as ads, banners, links, mobile applications, or search results. Regardless of means, sellers may be able to provide information or allow buyers to bid and transact immediately within the ads, banners, links, mobile applications, or search results. Additionally, a transaction can be facilitated through a redirected link. Fees paid by the sellers to utilize these means may vary based on the current market advertisement cost or based on the actual sales. Sellers may be able to create discounts, group discounts, or give the item out for free to attract buyers.

In some example embodiments, the seller may have various options to set fees, duration of ownerships, group bidders, and various other variables the system offers for the listing of the item for sale. It will be understood that in some embodiments, the trade process can be set up so as to enable the seller to select the buyer based on numerous criteria besides the amount of the monetary bid. These criteria can include the creditworthiness of the bidder. For example, the seller can prefer potential buyers with funded escrow accounts. Other criteria can also include a buyer's reputation assessed based on the feedback provider by the user community.

It will be further understood that methods for combinatorial portfolio aggregations in electronic trade, described herein, are not limited to aggregations of bids based on the bids for non-concurrent possessions. Other aggregations enabling the buyer to pay less and still be able to own or use the item are possible. Additionally, unlike the traditional trades or sales, the seller can lower the price to complete the transaction after the trade time has expired. Additionally, the seller can transact with monetary bids and/or with some non-monetary bids or all non-monetary bids.

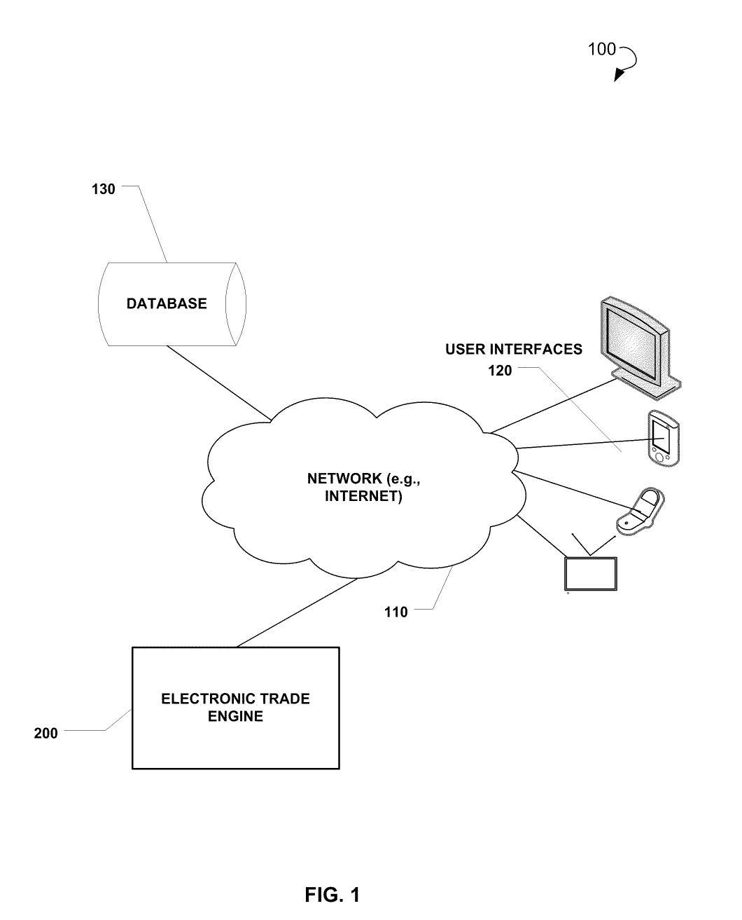

FIG. 1 is a block diagram showing a sample network environment 100 within which a system and method for combinatorial portfolio aggregations in electronic trade can be implemented, in accordance with an example embodiment. As shown in FIG. 1, the sample network environment 100 may comprise a network 110, user interfaces 120, a database 130, and an electronic trade engine 200. The network 110 can comprise a plurality of data processing nodes interconnected for the purpose of data communication. Other components of the network environment 100 can utilize the network 110 to receive, transmit, and store data as well as for the purpose of accessing remote resources.

The database 130 may be utilized to store data processed by the electronic trade engine 200. In some example embodiments, the data stored in the database 130 can originate in transactions external to the electronic trade engine 200. The database 130 can also store data related to various market participants who are the parties to the transactions. Such market participants can include buyers, sellers, trade bidders, trade watchers, or any other parties to online transactions. The user interfaces 120 can be included in various devices to facilitate transmitting and receiving data over the network 110. The user interfaces 120 can permit the market participants to interact with the electronic trade engine 200.

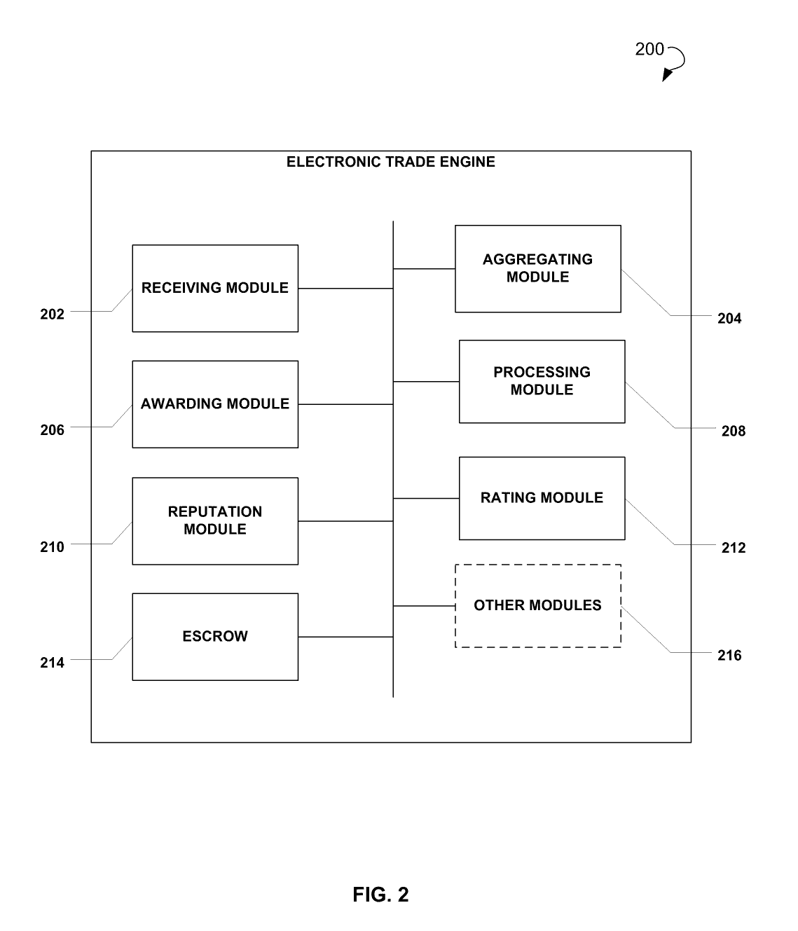

The electronic trade engine 200 can be utilized to process e-commerce transactions. The e-commerce transactions may comprise the buying and selling of goods or services over electronic systems such as the Internet and other computer networks. A wide variety of e-commerce may be conducted electronically over the network 110 and processed by the electronic trade engine 200. The transactions may include transfers of funds, online transaction processing, electronic data interchange, automated inventory management, and automated data collection. The electronic trade engine 200 can use the network environment 100 at least at some point in the transaction's lifecycle, although it may comprise a wider range of technologies. The electronic trade engine 200 is described by way of example with reference to FIG. 2.

FIG. 2 is a block diagram showing the electronic trade engine 200, in accordance with an example embodiment. The electronic trade engine 200 can include several components that may be configured to perform various operations. As shown in FIG. 2, the electronic trade engine 200 can comprise a receiving module 202, an aggregating module 204, an awarding module 206, a processing module 208, a reputation module 210, a rating module 212, an escrow module 214, and other optional modules 216. The components of the electronic trade engine 200 can facilitate an online trade transaction such as, for example, a trade. In a typical online trade process, the receiving module 202 can receive the data related to a listing posted by the seller as well as the data related to bids by the potential buyers.

The processing module 208 can process the data according to the rules of the trade and facilitate enforcement of such rules. The data can be stored in the database 130 (not shown). The seller can specify the trade form, including time limits, minimum or maximum limits on bid prices, and special rules for determining the winning bidder(s) and sale price(s). The processing module 208 can facilitate the trading process according to the nature of the trade and the settings specified by the seller. The trade can be direct, in which the seller is the offering party and the goal of the bidding is to drive the price up or reverse, in which the traditional roles of buyers and sellers are reversed, and the goal of bidding is to drive the price down.

Participants in a trade may or may not know the identities or actions of other participants. The methods for combinatorial portfolio aggregations in electronic trade can permit bidders to increase the bid amount by combining their bids in a portfolio bid. The aggregation of the bids is facilitated by the aggregating module 204. These methods are described in more detail below. The methods and systems for combinatorial portfolio aggregations in electronic trade are not limited to trades and in, some example embodiments, can be utilized in exchange of goods and/or services for other goods and/or services without a common unit of exchange. The awarding module 206 facilitates determination of the winning bid or the winning portfolio bid.

In some example embodiments, the reputation module 210 can enable the seller to take into account the reputation of the potential buyer. For example, if the reputation module determines that the potential buyer has a poor reputation for making timely payments, the bid associated with the potential buyer can be assigned lesser weight than the bid associated with a potential buyer having a better reputation for making timely payments.

Similarly, the escrow module 214 can be utilized to take into account whether or not the escrow associated with the bidder is funded by assigning a higher weight to the bid associated with a funded escrow. Other modules 216 can be utilized to assign higher or lower weight to specific bids based on predetermined criteria. The rating module 212 can assess the data produced by the reputation module 210, the escrow module 214, and the other modules 216 and assign an aggregated weight to a particular bid. Aggregated weights in conjunction with the monetary values associated with multiple bids may enable the seller to select the winning bidder.

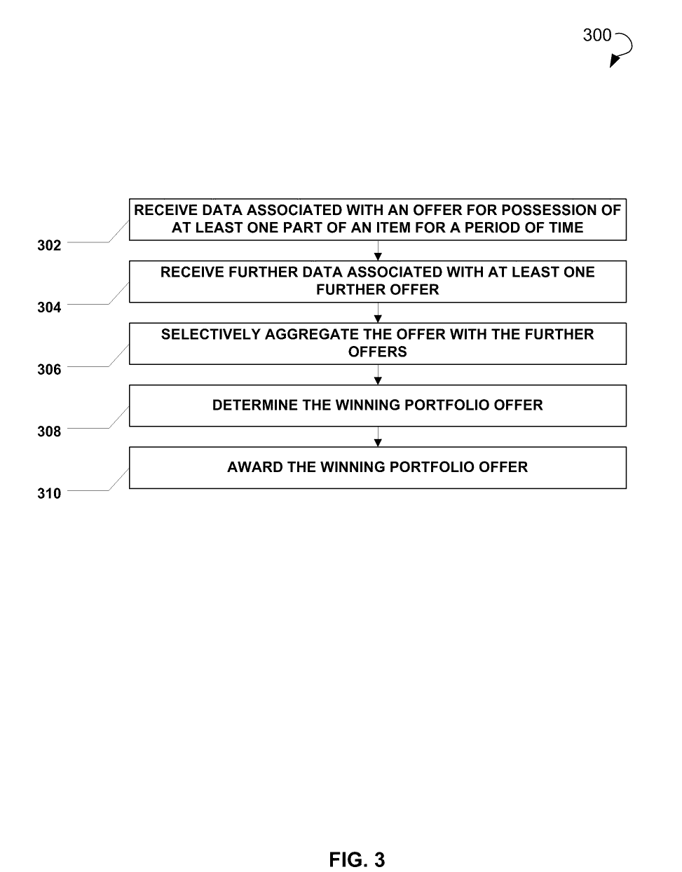

FIG. 3 is a flow chart showing a method 300 for combinatorial portfolio aggregations in electronic trade, in accordance with an example embodiment. The method 300 may be performed by processing logic that may comprise hardware (e.g., dedicated logic, programmable logic, microcode, etc.), software (such as run on a general-purpose computer system or a dedicated machine), or a combination of both. In one example embodiment, the processing logic resides at the electronic trade engine 200 illustrated in FIG. 2.

The method 300 may be performed by the various modules discussed above with reference to FIG. 2. Each of these modules may comprise processing logic. The method 300 may commence at operation 302 with the receiving module 202 receiving data associated with an offer for possession of at least one part of an item for a period of time. For example, in an online trade for a textbook, a bidder may specify a period of time coinciding with the term of a college semester. To facilitate placing such a bid, the user interfaces 120 of FIG. 1 may utilize a time slide associated with the listing. The bidder may bid to own the item at the conclusion of the trade. In such case, the processing module 208 may automatically determine that the bid is not to be aggregated with other bids. The bidder may also bid to own the item starting at a specific future date if permitted by the seller.

In some example embodiments, the bidder may indicate that his bid is not to be aggregated with other bids. If this is the case, the bid will not be aggregated with further bids. Otherwise, at operation 304, the receiving module 202 can receive further data associated with at least one further bid where the at least one further bidder selects to participate in the bid portfolio started by the first bidder. A further bidder can select a period of time which is not currently occupied by any bid or bid to replace the existing bidder in the same period of time.

In some example embodiments, the bid to own the item starting at a specific future date can also be replaced by a higher bid when the seller allows such replacements. As another option available to a seller, a buyer may bid to possess the item on certain dates or bid on a period of time associated with a certain event (e.g., for 5 days after another bidder). Thus, for example, the highest bidder may get the item for ×1 days, next highest bidder may get the item for ×2 days and so forth.

At operation 306, the aggregating module 204 can aggregate the bids for the item in a portfolio bid. The portfolio bid can include the highest bids for non-concurring time periods and the highest bid to own the item starting at a specific future date. At operation 308, the processing module 208 can determine the winning portfolio offer among a plurality of portfolio offers and at operation 310, the awarding module 206 can award the item to the winning portfolio offer.

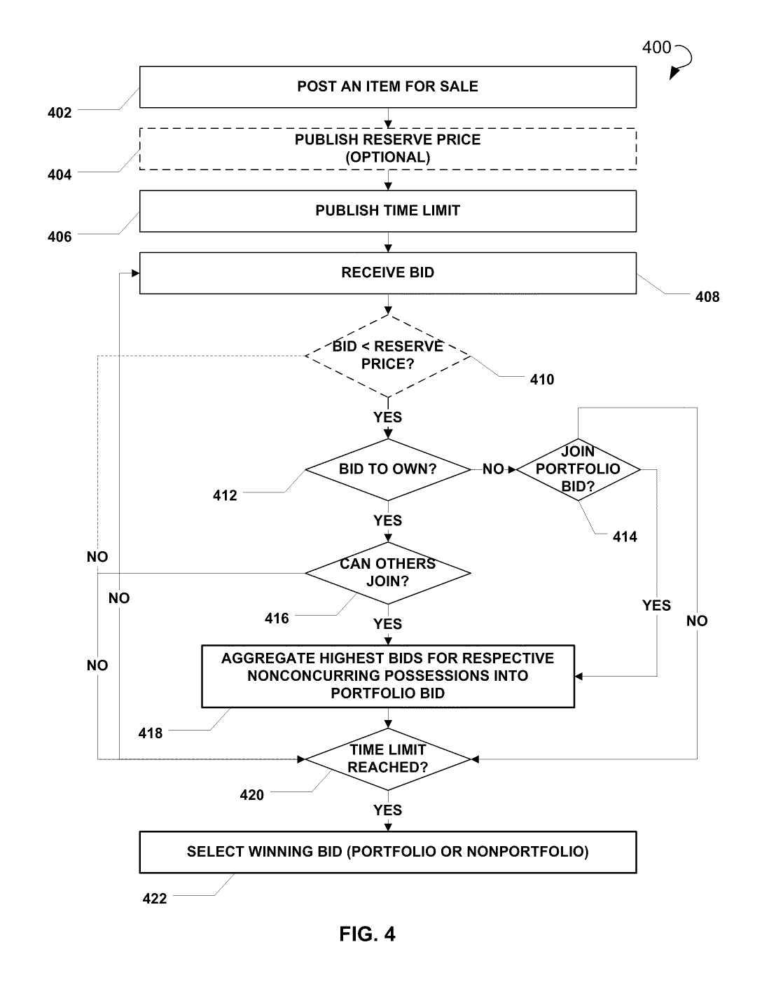

FIG. 4 is a flow chart showing a method 400 for combinatorial portfolio aggregations in electronic trade, in accordance with an example embodiment. The method 400 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the electronic trade engine 200 illustrated in FIG. 2. The method 400 may be performed by the various modules discussed above with reference to FIG. 2. Each of these modules may comprise processing logic.

The method 400 may commence at operation 402 with a seller posting an item for sale via one of the user interfaces 120 of FIG. 1. In some example embodiments, the seller can condition the sale upon a single bid or a portfolio bid exceeding a predetermined published reserved price. The reserve price can be published at operation 404. As shown at operation 404, the publication of the reserve price is optional. If the reserve price is not published, the reserve price cannot be seen by the bidders. In the seller preferences, the seller can select whether or not the reserve price is published. For example, the seller can specify that he reserves the right to cancel the sale unless a stand-alone or/and a portfolio bid posted within 10 days equals or is greater than $100. The time limit of the sale can be published at operation 406.

At operation 408, the receiving module 202 of the electronic trade engine 200 can receive a bid for the item. When a bidder bids, and the bid is an ownership bid, the bidder may set certain criteria for the portfolio bidding process as long as the criteria are allowed by the seller. For example, a bidder creating his own portfolio may specify the minimum bid amount. For example, the buyer can specify that the minimum bid amount is $2. This approach can later save the buyer some time by eliminating bids that do not match the criteria set. Once other bidders join the portfolio, the ownership bidder cannot be replaced. Another bidder bidding for the ownership of the item will need to start a separate ownership bid in another portfolio. If, on the other hand, the first bidder is not the ownership bidder, then a new bidder can bid to be the ownership bidder and set certain criteria (allowed by the seller) that must be met in order to join the portfolio. The seller has the right to decide when listing the item for sale whether the ownership bidder can or cannot be replaced.

At decision block 410, the processing module 208 may determine whether or not the bid equals or is greater than the published reserve price. In some example embodiments, a bid placed within the specified time limit becomes the winning bid unless there is a higher portfolio or non-portfolio bid. If the processing module 208 determines that the bid is equal to or greater than the published reserve price, the method 400 can proceed to decision 420, where it is determined whether the time limit of the trade has been reached. If the time limit has not been reached the method 400 can continue to accept bids at operation 408. If, on the other hand, the time limit has been reached at, the method 400 will proceed to operation 422, at which the winning bid is selected by the awarding module 206.

If it is determined that the bid exceeds the reserve price and the bidder doesn't want others to join, the method may proceed to 420. Other bidders can join the bid to further increase the total bid amount. Thus, if it is determined at decision block 410 that the bid is less than the reserve price, the method 400 can proceed to operation 412, in which the processing module 208 can determine whether or not the bid is to own the item starting at a specified time.

If it is determined at operation 412 that the bid is to own the item, the method 400 can proceed to decision block 416, where it can be determined by the processing module 208 whether other bids can be aggregated with this bid into a portfolio bid. The bidder can explicitly specify that the bid not to be aggregated. If this is the case, the method can proceed to decision block 420, where it is determined whether the time has expired. If it is determined that the time has expired, the method 400 can proceed to operation 422, where the winning bid is determined upon conclusion of the trade.

Referring back to operation 412, if on the other hand it is determined that the bid is not to own, the method 400 can proceed to decision block 414, where it can be determined whether or not the buyer wants to join an existing portfolio bid. If the buyer wants to join an existing portfolio bid, the bid will be placed within the context of the portfolio bid in which it will compete for a specific time period.

In some example embodiments, the bidder can join the portfolio bid having the lowest current bid for the desired time period within of a plurality of portfolio bids. The bidder can make a proxy bid for the desired time period by specifying the maximum price he is willing to pay. If it is determined that the bidder wants to join an existing portfolio bid, the bid is placed with an existing portfolio bid, and the method 400 proceeds to operation 422, in which the winning bid is determined.

In some example embodiments, a losing bidder of a lower portfolio bid can request to join the winning portfolio bid by sending a request to the seller or the highest bidder of the winning portfolio, if there is no conflict of interest with the current bidders. The losing bidder can also start another portfolio from the start to ensure better chances of being in the winning group.

Referring back to operation 412, if it is determined that the bidder wishes to place a bid to own the item, the bidder can decide at decision block 416 whether or not he prefers for his bid to be aggregated with other bids in an existing portfolio bid. In some example embodiments, the bidder can select not to join any existing portfolio bids, notwithstanding the fact that the bid is less than the reserve price. At the completion of the trade, the seller can choose to award the item to the bidder due to the lack of higher bids. If, however, the bidder permits other bids to be aggregated with his bid, the method can proceed to operation 418.

At operation 418, the aggregating module 204 can aggregate the highest bids for respective non-concurring possessions into a portfolio bid. At decision block 420, the processing module 208 may decide whether or not the time limit for the trade is reached. If it is decided that the time limit is reached, the method may proceed to select the winning bid among the portfolio and non-portfolio bids. In some example embodiments, before the winning bid is selected, the ownership bidder or the seller of the portfolio bid may eliminate one or more bids if the published reserve price is exceeded by the portfolio bid.

In some example embodiments, the seller can eliminate one or more bidders if the published reserve price is not reached and choose to transact with the remaining bidders. For example, the seller can eliminate the bidder bidding to own and then lease the item to the remaining bidders according to the placed bids. Upon completion of all lease periods, the ownership of the item reverts to the seller. If on the other hand, it is determined that the time limit is not reached, the method can return to operation 408 and receive a further bid. It will be noted that in some example embodiments, the reserve price is not visible. If the seller prefers not to publish the reserve price, the ownership bidder can only choose to eliminate other bidders after their portfolio wins the trade.

Once the winning portfolio bid is selected, the possession of the item may be transferred from the seller to the first chronological owner within a predetermined time period. Each consecutive owner (if more than one) may be made responsible for the next respective transfer to the next chronological owner until the item is transferred back to the seller or is transferred to the eventual owner. The specifics of each transfer may be agreed upon by the buyer, for example, at the time the bid is placed. These specifics can spell out, for example, the party responsible for the shipping costs and the party responsible in case the item does not reach its intended destination. In addition, images of the item may be posted online to ensure the item is still in substantially unchanged condition as it is transferred to the next bidder.

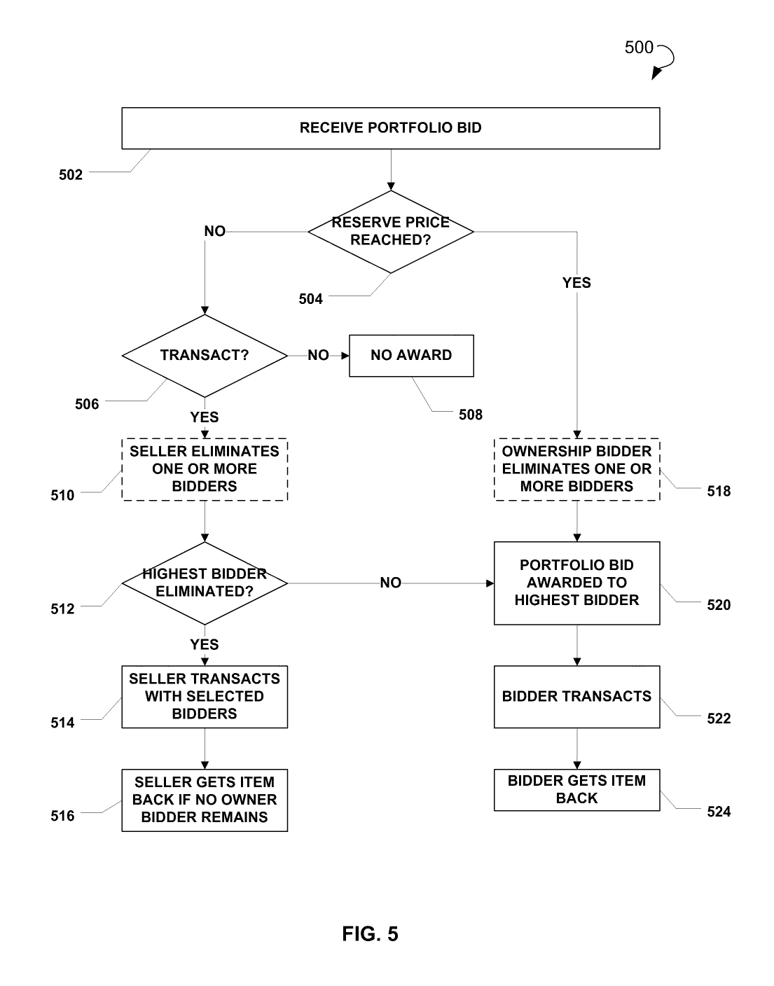

FIG. 5 is a flow chart showing a method 500 for combinatorial portfolio aggregations in electronic trade, in accordance with an example embodiment. The method 500 may be performed by processing logic that may comprise hardware (e.g., dedicated logic, programmable logic, microcode, etc.), software (such as run on a general-purpose computer system or a dedicated machine), or a combination of both. In one example embodiment, the processing logic resides at the electronic trade engine 200 illustrated in FIG. 2. The method 500 may be performed by the various modules discussed above with reference to FIG. 2. Each of these modules may comprise processing logic.

The method 500 may commence at operation 502 with the receiving module 206 receiving a portfolio bid. As already mentioned above, a portfolio bid is an aggregation in a single bid of the highest bids for respective non-concurring possessions of an item and the bid to own the item. At decision block 504, the processing module 208 can determine whether or not the reserve price published by the seller is reached. If it is determined that the reserve price is reached, the ownership bidder can be permitted to eliminate one or more bidders at operation 518. If, on the other hand, it is determined that the reserve price is not reached, the seller can decide at operation 506 whether or not to award the item to the portfolio bid. If the seller decides not to award the item, the trade ends with no winner at operation 508.

If, on the other hand, the seller decides to award the item, the seller can optionally eliminate one or more bidders at operation 510. At decision block 512, it can be determined whether or not the highest bidder is eliminated. If it is determined that the highest bidder is eliminated, the seller can award the item at operation 514 to the remaining bidders according to their respective bids. At the conclusion of all leases, the seller receives the possession of the item as shown at operation 516 if all owner bidders were eliminated during the trade process. Otherwise, the item will go the highest owner bidder. In some example embodiments, the seller may choose not to get the item back and, instead, sell the item to a bidder selected from the portfolio bid bidders. If the highest bidder is not eliminated at decision block 512, the portfolio bid can be awarded to the highest bidder at operation 520 and the highest bidder is to transact with the remaining bidders of the winning portfolio bid at operation 522. At operation 518, the highest bidder can optionally eliminate one or more bidders he deems unnecessary for the portfolio bid to remain competitive. At the conclusion of all transactions, the highest bidder receives the possession of the item as shown at operation 524. In some example embodiments, the highest bidder can forfeit his ownership to the benefit of the next highest bidder. The next highest bidder can similarly surrender the ownership to the next highest bidder and so forth until the last bidder.

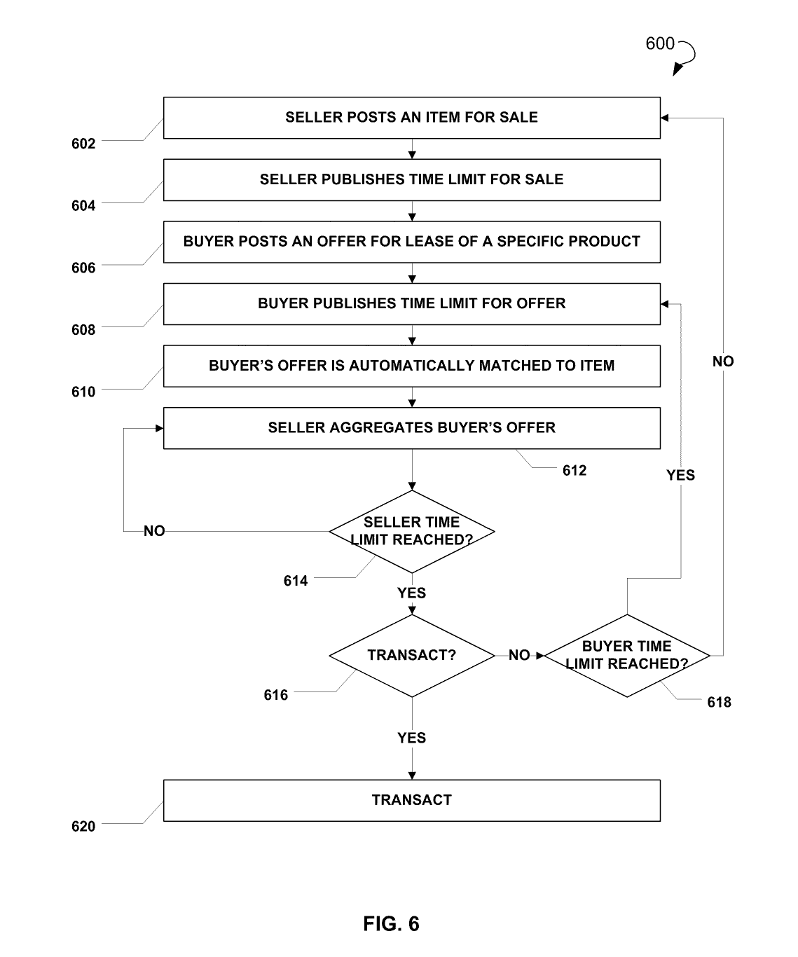

FIG. 6 is a flow chart showing a method 600 for combinatorial portfolio aggregations in electronic trade, in accordance with an example embodiment. The method 600 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the electronic trade engine 200 illustrated in FIG. 2. The method 600 may be performed by the various modules discussed above with reference to FIG. 2. Each of these modules may comprise processing logic.

The method 600 may commence at operation 602 with the seller posting an item for sale. At operation 604, the seller can publish the time limit for the sale of the item. The time limit can indicate the date at which the winner is to be determined. At operation 606, a buyer can post an offer to lease or own a specific item. This offer can be posted at the same marketplace as the offer posted by the seller. The buyer can provide a time limit for his offer at operation 608. The time limit is the date by which the offer is to be accepted. At operation 610, the seller's offer can be matched to the buyer's offer automatically. In some example embodiments, the buyer and/or the seller can manually match their offers. The seller can receive one or two further offers and aggregate the offers at operation 612. In some example embodiments, the seller can use the bids aggregated in the previous iteration and re-aggregate the previous bids with the new bids.

At decision block 614, it can be determined whether or not the time limit specified by the seller is reached. If it is determined that the time limit is reached, the seller can decide at decision block 616 whether or not to transact with the bidders associated with the aggregated bid. If the seller decides to transact, the seller will award the item to the winning aggregated bid at operation 620. If, on the other hand, the seller decides not to transact, the method can proceed to decision block 618, where it can be determined whether the time limit associated with buyer's offer has expired. If the time limit has not expired, the seller can repost the item for sale and re-enter the buyer's bid in an aggregated bid.

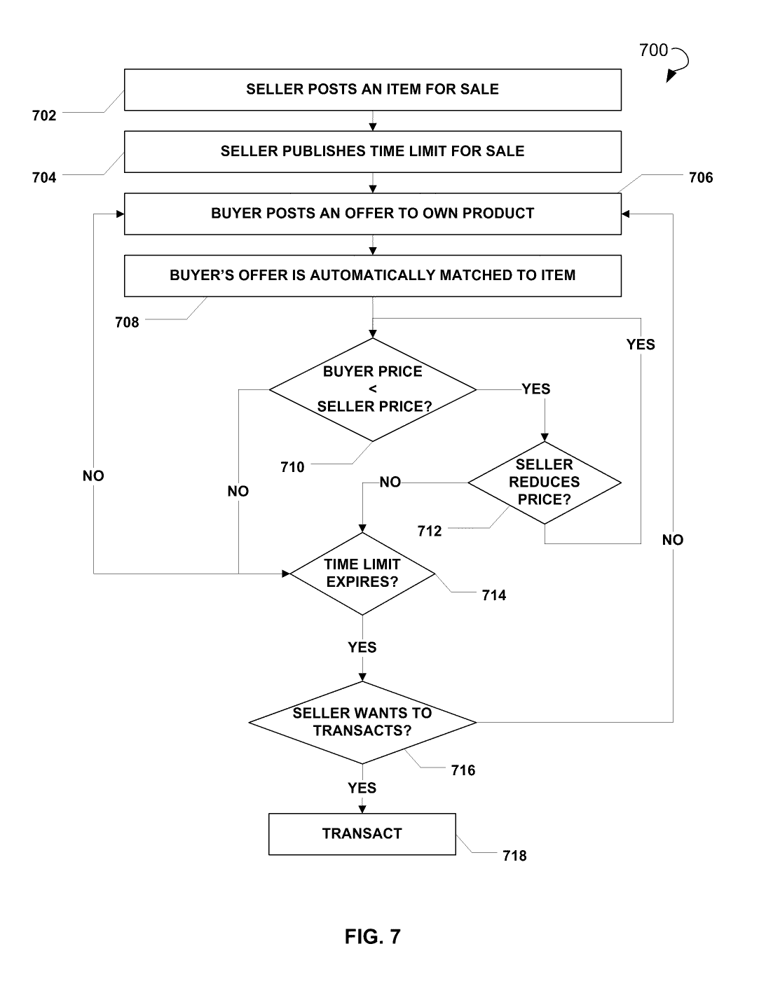

FIG. 7 is a flow chart showing a method 700 for combinatorial portfolio aggregations in electronic trade, in accordance with an example embodiment. The method 700 may be performed by processing logic that may comprise hardware (e.g., dedicated logic, programmable logic, microcode, etc.), software (such as run on a general-purpose computer system or a dedicated machine), or a combination of both. In one example embodiment, the processing logic resides at the electronic trade engine 200 illustrated in FIG. 2. The method 700 may be performed by the various modules discussed above with reference to FIG. 2. Each of these modules may comprise processing logic.

The method 700 may commence at operation 702 with a seller posting an item for sale. At operation 704, the seller can publish a time limit for the sale. At operation 706, a buyer can post an offer to own an item. The buyer may not specify any time limit on his offer. At operation 708, the buyer's offer can be automatically matched to the item posted by the seller. At decision block 710, it can be determined whether or not the buyer's price limit is less than the seller's price limit. If the buyer's price limit is less than the seller's price limit, the seller can reduce its price. At decision block 712, it can be determined whether or not the seller has reduced the price. If the seller has reduced the price, the method 700 can return to decision block 710 to determine whether the buyer's price is still less than the seller's price. If, at decision block 710, it is determined that the buyer's price is not less than the seller's price, the method can proceed to decision block 714 to determine whether the time limit has expired. If the time limit has expired, a transaction can occur at operation 718. If the seller does not reduce the price at decision block 712, the method 700 can proceed to decision block 714.

At decision block 714, the processing module 208 can determine whether the time limit established by the seller has expired. If the time limit has expired, the method 700 can proceed to decision block 716. At decision block 716, the processing module 208 can determine whether the seller wants to transact notwithstanding the fact that the buyer's price is below the seller's price. If the seller wants to transact, the transaction occurs at operation 718. Otherwise, the method 700 proceeds to operation 706 where the buyer can repost his offer.

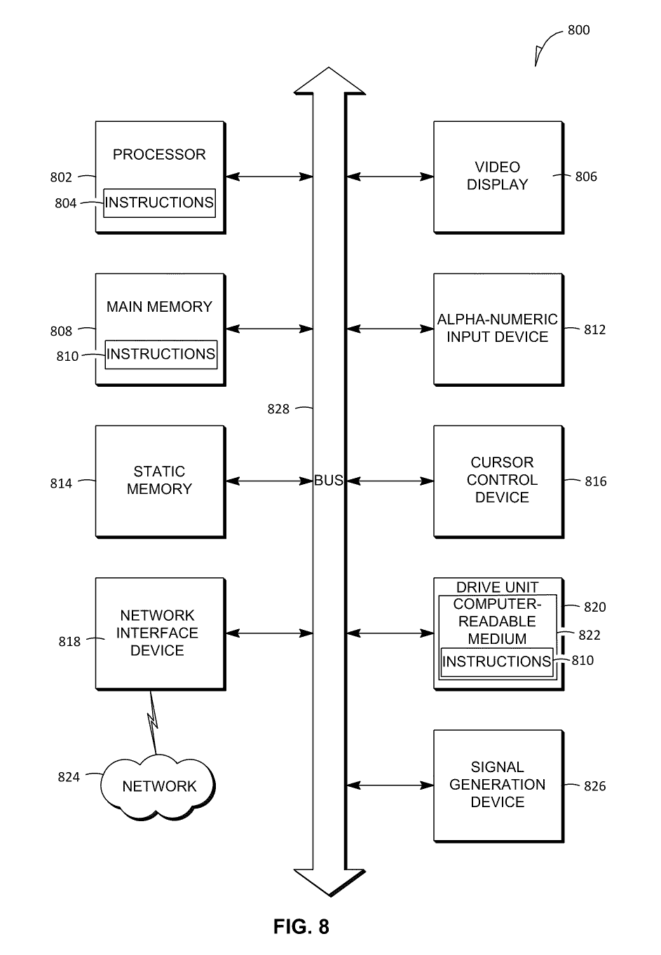

FIG. 8 is a diagrammatic representation of an example machine in the form of a computer system 800, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a mobile telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor or multiple processors 802 (e.g., a central processing unit (CPU), a graphics processing unit (GPU), or both), a main memory 808, and a static memory 814, which communicate with each other via a bus 828. The computer system 800 may further include a video display unit 806 (e.g., a liquid crystal display (LCD)). The computer system 800 may also include an alphanumeric input device 812 (e.g., a keyboard), a cursor control device 816 (e.g., a mouse), a disk drive unit 816, a signal generation device 826 (e.g., a speaker) and a network interface device 818.

The disk drive unit 820 includes a computer-readable medium 822 on which is stored one or more sets of instructions and data structures (e.g., instructions 810) embodying or utilized by any one or more of the methodologies or functions described herein. The instructions 810 may also reside, completely or at least partially, within the main memory 808 and/or within the processors 802 during execution thereof by the computer system 800. The main memory 808 and the processors 802 may also constitute machine-readable media.

The instructions 810 may further be transmitted or received over a network 824 via the network interface device 818 utilizing any one of a number of well-known transfer protocols (e.g., Hyper Text Transfer Protocol (HTTP)).

While the computer-readable medium 822 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like.

The example embodiments described herein may be implemented in an operating environment comprising software installed on a computer, in hardware, or in a combination of software and hardware.

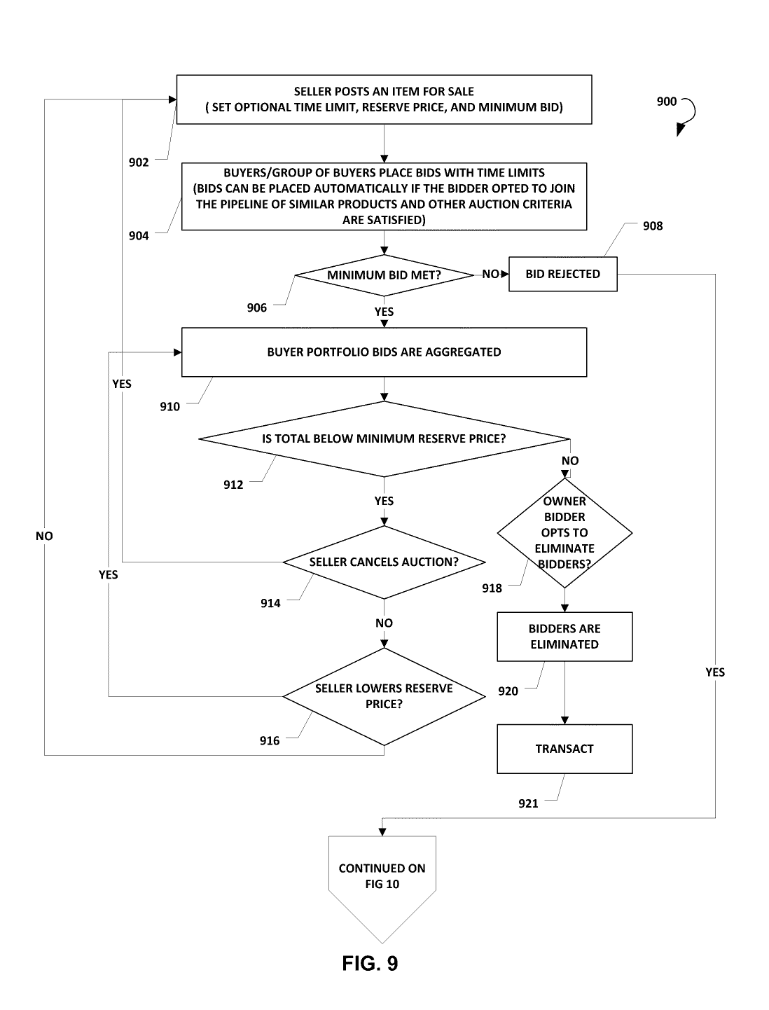

FIG. 9 is the first part of flow chart showing method 900 for combinatorial portfolio aggregations in electronic trade using a queue of pipeline offers, in accordance with an example embodiment. As shown in FIG. 9, method 900 can commence at operation 902 with a seller posting an item for sale. Optional attributes such as the trade time limit, the reserve price, and the minimum bid can be associated with the item. For example, the seller can post the item for 10 days with the reserve price of $100 and the minimum bid of $1. Multiple items can be posted.

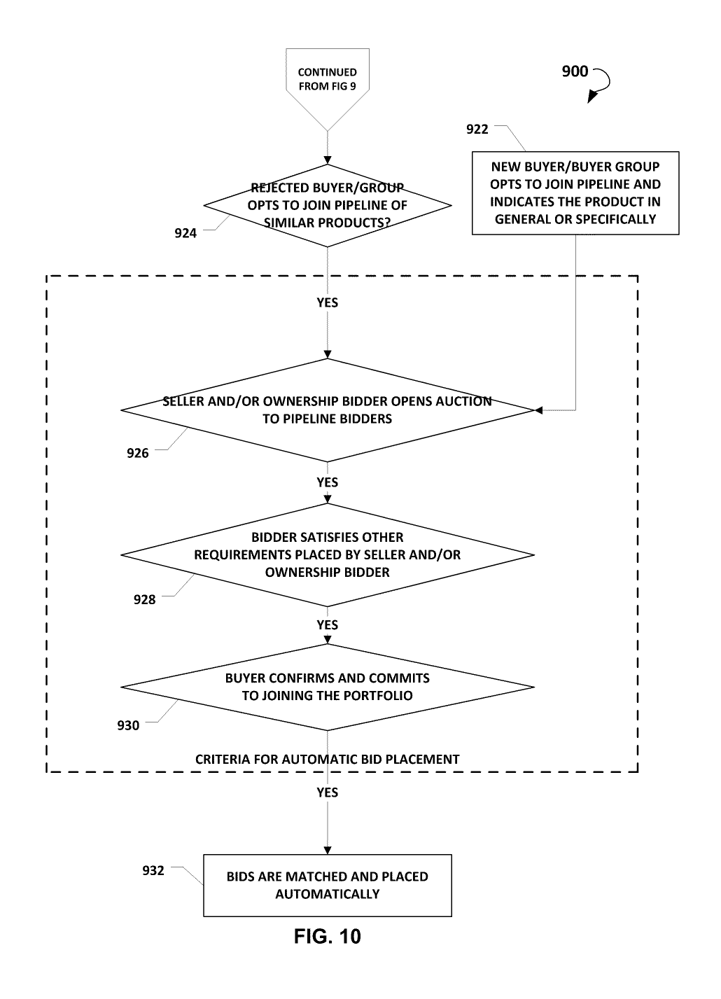

Once the trade commences, buyers can place bids, either individually or within a particular portfolio bid, at operation 904. In some example embodiments, the bids can be placed automatically if the bidder or the group of bidders has opted to join the pipeline of similar items and other trade criteria are satisfied. At decision block 906, for each bid, it can be determined whether the bid satisfies the minimum bid amount. If the bid does not satisfy the minimum bid amount, the bid can be rejected at operation 908. When the bid is rejected, the individual bidder or the leader of the bidding group can decide to join the pipeline of similar items at operation 924 of FIG. 10.

If, on the other hand, the minimum bid amount is satisfied at operation 906, the buyer portfolio bid is aggregated at operation 910. As bidders bid, it can be determined at operation 912 whether the aggregated bid is still below the reserved price. If the aggregated bid is still below the reserve price, the seller can decide whether to cancel the action at decision block 914. If the seller decides to cancel the trade at decision block 914, the seller can repost the item (or multiple items) at operation 902. If, on the other hand, the seller decides not to cancel the action even though the reserve price is not met, the seller can decide to lower the reserve price at operation 916. If the seller does not lower the reserve price, the method 900 can proceed to operation 902 where the item can be reposted. Alternatively, the seller can decide to lower the reserve price in order for the aggregated bids to reach the minimum reserve price and proceed to operation 910.

Continuing with the above example, where the seller posts the item for 10 days with the reserve price of $100 and the minimum bid of $1, the first bidder can bid $50 to own the item. The second bidder can bid $20 to have the item for 2 days. The third bidder can bid $5 to have the item for 5 days. The fourth bidder can bid $5 to have the item for 2 days. The fifth bidder can bid $1 to have the item for 8 days. The sixth bidder can bid $0.50 to have the item for 8 days. The sixth bidder can be rejected because the bid is below the $1 minimum. In response, the sixth bidder can elect to join the pipeline of similar items. Because the total aggregated bid is $81, which is below the $100 non-published reserve price, the seller can cancel the trade or dynamically lower the reserve price to under $81 (e.g. $80).

FIG. 10 is the second part of flow chart showing method 900 for combinatorial portfolio aggregations in electronic trade using a queue of pipeline offers, in accordance with an example embodiment. As shown in FIG. 10, the buyer or a group of buyers, whose bids are rejected at operation 908 of FIG. 9, can opt to join the pipeline of similar items at operation 924. Additionally, new bidders at operation 922 can join the pipeline of similar items without being rejected.

At decision block 926, it can be determined whether the seller or the ownership bidder opens the trade to pipeline bidders. If the trade is opened to other bidders/groups at block 926, and the bidder satisfies other requirements established by the seller or the ownership bidder at decision block 928, the bidder or the leader of a group of bidders can be asked to confirm and commit to joining the portfolio bid at decision block 930. If the bidder satisfies the requirements and the buyer or the highest bidder commits to joining the portfolio, the bid is automatically posted at operation 932.

Thus, the offer can be matched to the item based on the data associated with the offer as well as the item properties and the item transfer criteria. Based on the results of this match, the offers are selectively aggregated into a portfolio bid. It will be noted that the queue of pipeline offers can be created by an individual seller/buyers or a group of sellers/buyers. In some example embodiments, the bidder can select the extent of the similarities between the items in the pipeline he is willing to accept.

For example, the sixth bidder mentioned above with reference to FIG. 9 was rejected because his bid failed to satisfy the $1 minimum bid rule. The sixth bidder can opt to join a pipeline of similar items that have no minimum bid requirement. Once the requirements are verified, the buyer can be notified that he is able to join another portfolio automatically. Example requirements can include a decision by the seller or the ownership bidder to open the trade to the bidders in the pipeline without the bidders having to first make a bid. Additionally, the bidder can be required to confirm and commit to joining the portfolio. Thus, the pipeline is a pool of open bids. Because the seller can be selling multiple items, the sixth bidder can become a part of a different portfolio bid if the minimum bid amount is not required. In some example embodiments, the seller can lower the price separately for each portfolio bid. Additionally, the seller can choose to have the same items without the sale price “open trade format.”

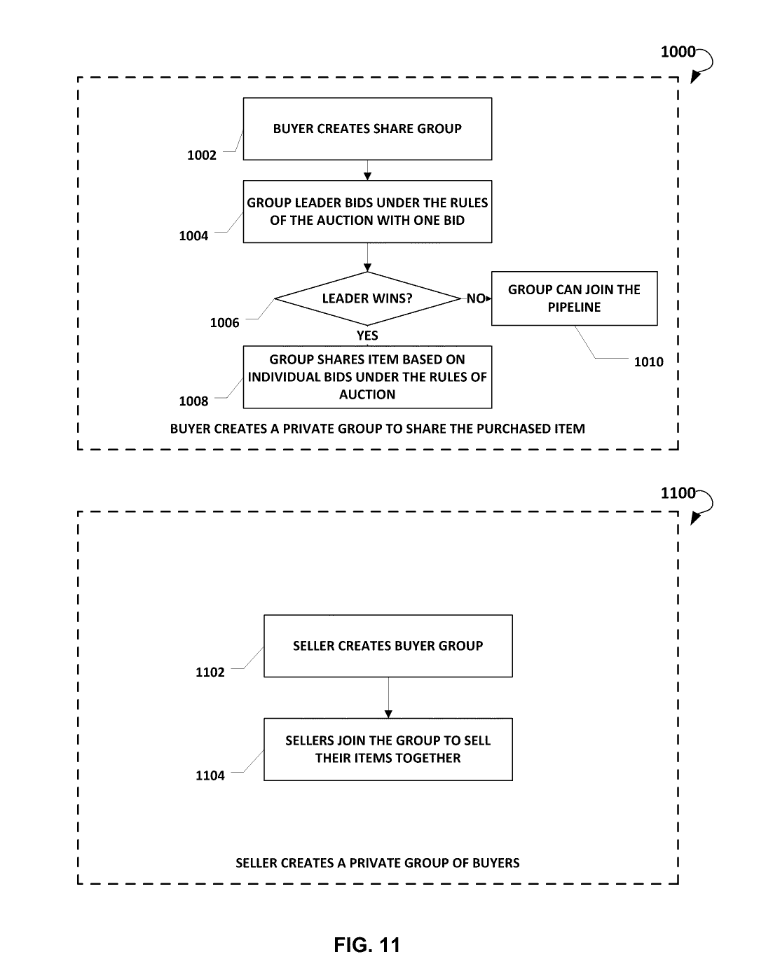

FIG. 11 is a flow chart showing methods 1000 and 1100 for creation of buyer and seller groups, in accordance with an example embodiment. The method 1000 can commence at operation 1002 with a buyer creating a share group to bid at a trade or to participate in a pipeline. At operation 1004, the buyer who is the group leader can bid following the rules of the trade with an aggregated bid. If it is determined at decision block 1006 that the leader of the group wins the trade, the group can share the item at operation 1008 based on the individual bids under the general rules of the trade. If, on the other hand, it is determined at decision block 1006 that the leader of the group of buyers does not win the trade, the group can join the pipeline at operation 1010. If the group leader wins the trade but is not the ownership bidder, the group leader must transfer the item from his group to the next highest bidder of the portfolio bid. In some example embodiments, the group leader may have the person in his group who is in possession of the item last to perform the transfer.

However, if a buyer creates his own private group to share items purchased or already owned, the buyer can post the item and allow other bidders to bid for the item within the private group. Other buyers can bid to have the item under the rules applied from the rest of community. However, the bidding is only open to the group members. As the flow chart of method 1100 illustrates, sellers can also create their own group of buyers and/or sellers. Thus, method 1100 can commence with a seller creating a buyer group at operation 1102. At operation 1104, other sellers can join the group to sell their items together.

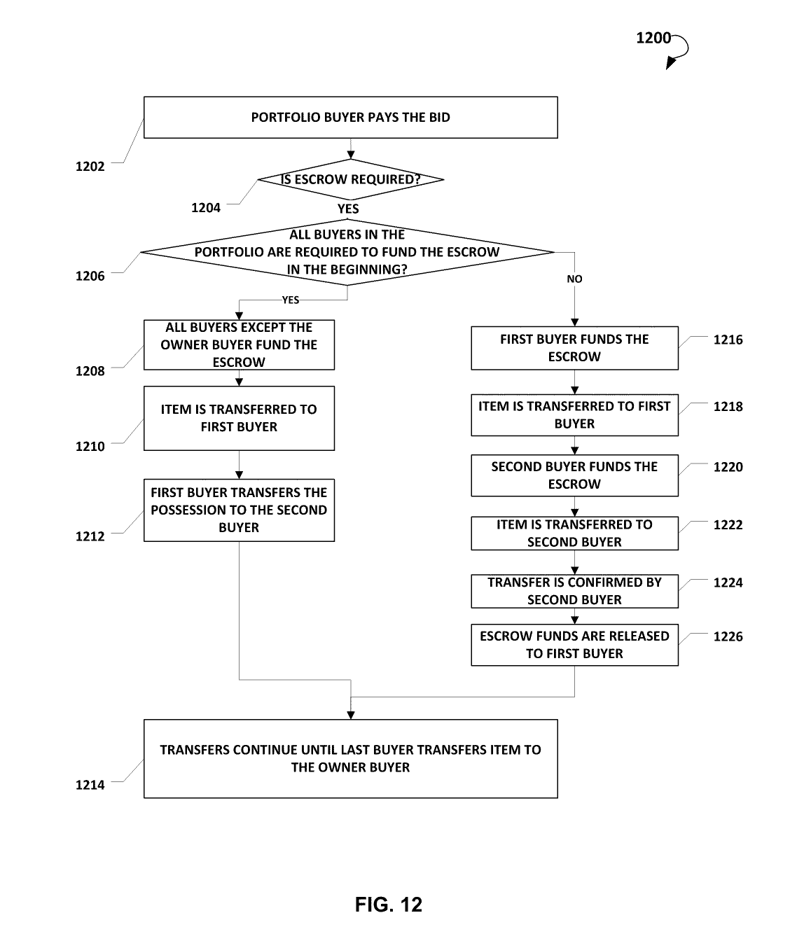

FIG. 12 is a flow chart showing method 1200 for combinatorial portfolio aggregations in electronic trade using an escrow, in accordance with an example embodiment. The method 1200 can commence at operation 1202 with the portfolio buyers paying for the item they won. At decision block 1204, it can be determined whether the escrow is required. The escrow can be used to guarantee the transfer of the item from one portfolio bidder to another and the eventual transfer of the item back to the owner. If it is determined at decision block 1204 that the escrow is required, the portfolio buyers will be required to fund the escrow. In some example embodiments, the escrow must be paid by all buyers before the first transfer occurs, with the escrow funds being released after the item is transferred to the owner. If there is a break in the bid or escrow payments, that bidder can be skipped and the next bidder can be notified. The disruptive behavior may be recorded in the bidder reputation profile, and the whole chain may be notified.

In other example embodiments, the escrow must be paid by each buyer before the item is transferred to this buyer, and the escrow funds are released once the transfer to the next successive buyer is confirmed. If there is a break in the bid or escrow payments, that bidder can be skipped and the next bidder can be notified. The disruptive behavior may be recorded in the bidder's reputation profile and the whole chain may be notified. Thus, at decision block 1206, it can be determined whether all buyers in the portfolio are required to fund the escrow before the first transfer occurs. If it is determined at decision block 1206 that all buyers are required to fund the escrow, the method 1200 can proceed to operation 1208 where all buyers except for the owner buyer fund the escrow. The item can be transferred to the first buyer at operation 1210 and from the first buyer to the second buyer at operation 1212. The transfers can continue until the last buyer transfers the item to the owner buyer at operation 1214. If the process flows from operation 1208, escrow funds may be released to the bidders once the owner receives the item.

If, on the other hand it is determined at decision block 1206 that the buyers are required to fund the escrow in the step fashion, the first buyer can fund the escrow at operation 1216. The item can be transferred to the first buyer at operation 1218. At operation 1220, the second buyer can fund the escrow and the item can be transferred to the second buyer at operation 1222. Once the transfer to the second buyer is confirmed at operation 1224, the funds can be released to the first buyer at operation 1226. The escrowing and releasing of the item during the transfers may continue until the last buyer transfers the item to the owner buyer at operation 1214. If the last buyer is the owner, no escrow is needed unless all buyers pay the escrow in the beginning. In some example embodiments, the seller can reacquire the item by paying a predetermined amount (for example, $0.01) to the last person to possess the item. The seller can have an option to change the predetermined amount to $0 and get the item back.

For example, the seller or the community of the portfolio can request an escrow, which is equal to the amount paid for the item (100% or the percentage determined by the owner winner) to make sure that everyone in line will get the item. Thus, if the $2 escrow must be paid in the beginning, a buyer who bid $2 to have the item for 2 days must pay $2 in the beginning. The $2 will be refunded to the buyer after the last transfer occurs. If, on the other hand, the escrow is paid in the step fashion, each buyer must pay 100% or the percentage determined by the owner winner of the total amount (e.g. $80) before the transfer takes place. In some example embodiments, the seller or the owner bidder can put the item into an infinite loop. The item would be transferred to the next person for an indefinite period of time until a bid for the next transfer.

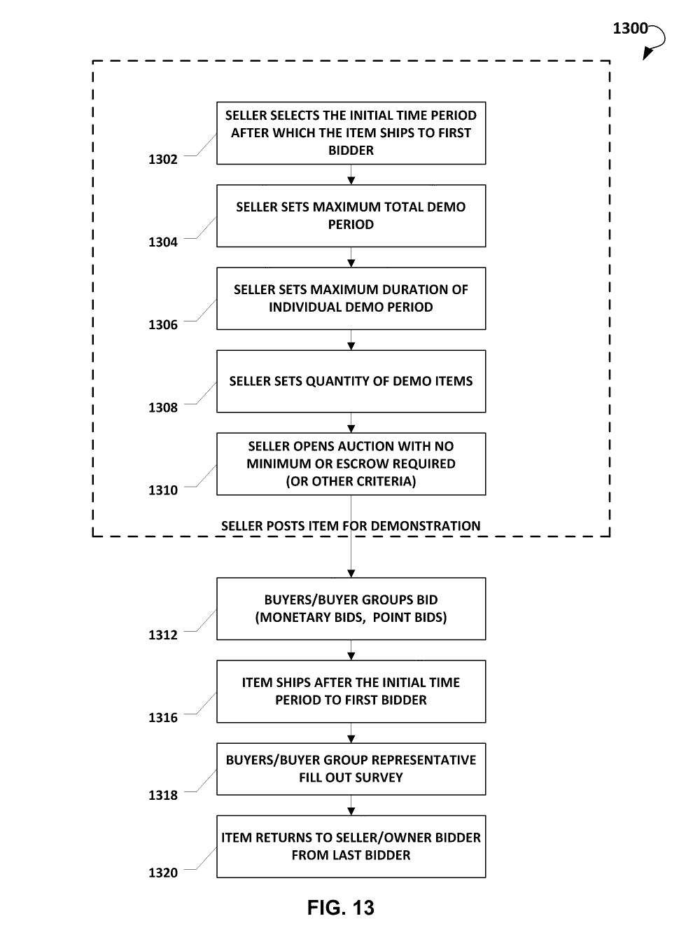

FIG. 13 a flow chart showing a method 1300 for demonstration of an item, in accordance with an example embodiment. The method 1300 can commence at operation 1302 with the seller selecting the initial time period after which the items can ship to the first buyer. Then, at operation 1304, the seller can set the maximum total demo period. At operation 1308, the seller can set the quantity of the items being demonstrated. At operation 1310, the seller opens trade with no minimum bid amount or escrow required. At operation 1312, the buyer can bid for the item. The bid can be monetary or non-monetary. At operation 1316, the items can ship after the initial time period to the first bidder. At operation 1318, the buyer representative can fill out a survey and at operation 1320, the items can be returned to seller or the owner bidder by last bidder.

Thus, a seller can post an item for a “demonstration” in order to share the item in exchange for a survey and/or to sell the item to the highest bidder. For example, the seller can “demonstrate” the item for 100 days, 10 days for each bidder. The initial period can be set to 20 days after the demonstration commences. The item must be returned after 100 days to either the original owner or the highest bidder. Multiple items can be demonstrated within an open trade format with no minimum bid and/or escrow required. Nonpaying bidders can be asked to complete a survey after having the item. The survey can include, for example, age, geography, tenure on site, and reputation. The survey can be, for example, in the form of essay responses and telephone calls.

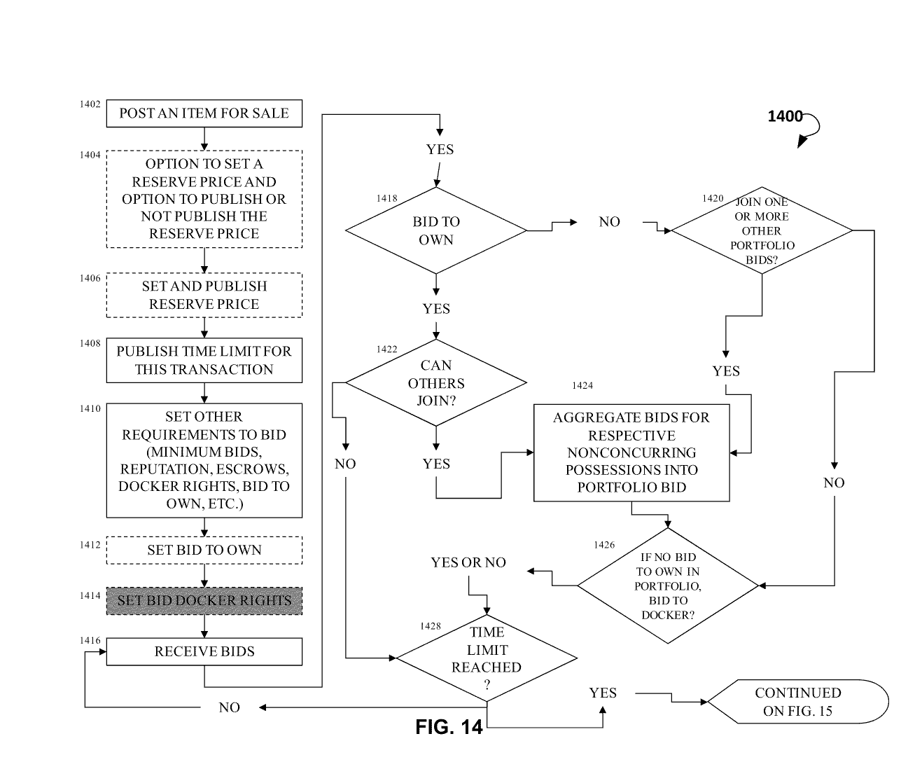

FIG. 14 is a flow chart showing a method 1400 for combinatorial portfolio aggregations in electronic trade using a docker bidder, in accordance with an example embodiment. The method 1400 may commence at operation 1402 with a seller posting an item for sale. The seller may decide to have a docker bidder in the portfolio group because no bidder has bid for the ownership of the item or if the ownership is not allowed at all. The seller can set criteria for becoming a docker.

At operation 1404, the seller may optionally set a reserve price, which may or may not be published. If the seller chooses to publish the reserve price, the reserve prices may be published at operation 1406. At operation 1408, a time limit set for this transaction may be published. Bids may not be accepted after the time limit expiration. Other requirements for the bidding process may be set at operation 1410. The requirements may include minimum bids and whether or not the information related to the reputation of prospective bidders is to be reported or taken into the account when accepting the bids. Other requirements may include whether or not the escrow will be established for the transaction and if so, when and how the escrow is to be funded. Other requirements may include “docker” rights that describe how the item is to be transferred out of a portfolio bid when there is no owner bidder or the reversion of ownership to the seller. Other requirements may specify how an ownership bid is to be placed. It will be understood that other criteria pertaining to the conduct of the transaction can be set at operation 1402 and not limited to the foregoing example requirements.

The method 1400 may optionally proceed to operation 1412 where the bid to own criteria may be set and then to operation 1414, where docker rights may be specified. Once the requirements and criteria for the trade are set, the method 1400 may proceed to operation 1416 to receive bids. At decision block 1418, it may be determined whether or not the received bid is to own the item. If the bid is an ownership bid, the method 1400 may proceed to decision block 1422 where it can be determined whether or not the ownership bidder permits other bidders to join his or her bid. If it is determined at decision block 1422 that other bidders can join the bid placed by the ownership bidder, the method 1400 may proceed to operation 1424, where bids for respective non-concurrent possessions of the item are aggregated into a portfolio bid.

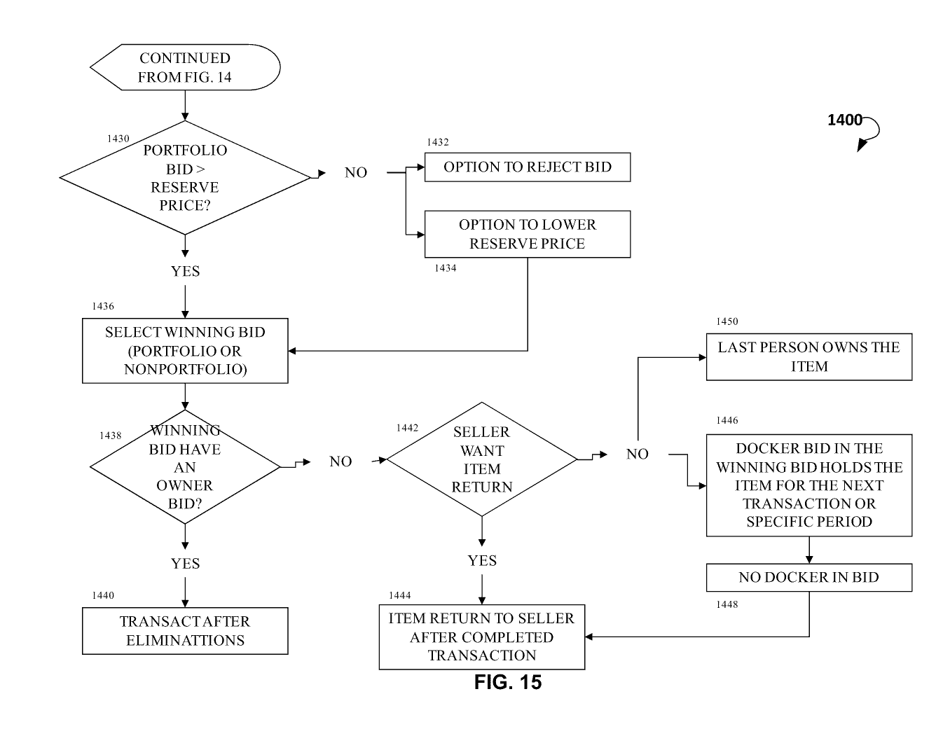

If, on the other hand, it is determined at decision block 1418 that the bid is not an ownership bid, the method 1400 may proceed to decision block 1420 to determine whether or not the bidder wishes to join one or more other portfolio bids. If the bidder wishes to join another portfolio bid, his or her bid may be aggregated with other bids for respective non-concurring possessions into a different portfolio bid at operation 1424. If, at decision block 1422 the ownership bidder decides that other bidders may not join his bid, the method 1400 may proceed to decision block 1428, where it is determined whether or not the time limit published at operation 1408 is reached. If the time limit is not reached, the method 1400 continues to receive bids at operation 1416. If at decision block 1420 it is determined that the non-ownership bidder does not wish to join any existing portfolio bid, the method 1400 may proceed to decision block 1426, where it can be determined whether or not the bidder wishes to be a docker bidder (to possess the item until the possession is transferred to a different individual or portfolio bidder). If the bidder wishes to be a docker bidder, the method 1400 may continue to decision block 1428, where it can be determined whether or not the time limit for the transaction has been reached. If the bidder doesn't wish to be a docker, the method 1400 may proceed to operation 1428. Once the time limit is reached, the method 1400 may continue to decision block 1430 in FIG. 15.

Continuing with FIG. 15, it can be determined at decision block 1430, after the time limit has expired, whether or not the portfolio bid is greater than the reserved price. If the portfolio bid is greater than the reserve price, the method 1400 may proceed to select the winning bid (either portfolio or non-portfolio) at operation 1436. If the portfolio bid is not greater than the reserved price, the seller may reject the bid at operation 1432 or lower the reserve price at operation 1434 so that the new reserve price is less than the portfolio bid. Thereafter, the method 1400 may proceed to operation 1436, where winning bid can be selected.

At decision block 1438, it can be determined whether or not the winning bid has an ownership bid. If there is an ownership bid, the transaction can be completed after selected bidder eliminations take place at operation 1440. If, on the other hand, there are no ownership bidders, it can be determined at decision block 1442 whether or not the ownership of the item is to revert to the seller. If the ownership is to revert to the seller, the item is to be returned to the seller at operation 1444 after the transaction is completed. If, on the other hand, the seller does not wish the item to be returned, the last bidder to possess the item may own the item at operation 1450. Alternatively, at operation 1446, if there is a docker bid in the winning portfolio, the docker bidder may possess the item either until it is transferred to another bidder in a different portfolio (or a single non-portfolio bidder) or for a certain predetermined period of time. If, on the other hand, it is determined at operation 1448 that there is no docker bidder in the portfolio, the item will return to the seller after the transaction is completed at operation 1444.

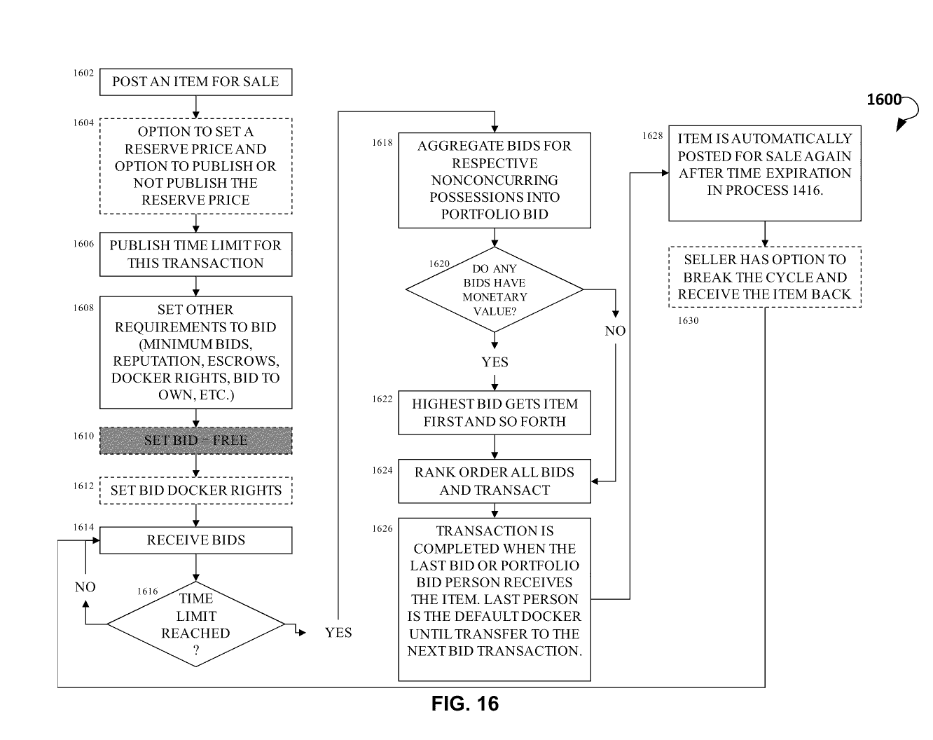

FIG. 16 is a flow chart showing a method 1600 for combinatorial portfolio aggregations in electronic trade using a docker bidder, in accordance with an example embodiment. The method 1600 may commence at operation 1602 with a seller posting an item for sale. At operation 1604, the seller may optionally set a reserve price, which may or may not be published. At operation 1606, a time limit set for this transaction may be published. Bids may not be accepted after the time limit expiration. Other requirements for the bidding process may be set at operation 1608. The requirements may include minimum bids and whether or not the information related to the reputation of prospective bidders is to be reported or taken into the account when accepting the bids. Other requirements may include whether or not the escrow will be established for the transaction and if so, when and how the escrow is to be funded. Other requirements may include “docker” rights that describe how the item is to be transferred out of a portfolio bid when there is no owner bidder or reversion of ownership to the seller. Other requirements may specify how an ownership bid is to be placed. It will be understood that other criteria pertaining to the conduct of the transaction are not limited to the foregoing example requirements.

The method 1600 may proceed to an optional operation 1610 where the seller can set the bid amount. The seller may set the minimum bid to be zero as shown at operation 1610. At optional operation 1612, the seller may set the bid docker rights, establishing criteria by which a bidder who wishes not to place an ownership bid is allowed to possess the sale item for a certain period of time or until it is transferred to another bidder. Once the requirements and criteria for the trade are set, the method 1600 may proceed to operation 1614 and start receiving bids. After each received bid, the method 1600 may proceed to decision block 1616 to determine whether or not the time limit published at operation 1606 is reached. If the time limit is not reached, the method 1600 continues to receive bids at operation 1614. If it is determined at decision block 1616 that the time limit is reached, the method 1600 can continue to operation 1618 where the bids received at operation 1614 may be aggregated with other bids for respective non-concurring possessions into a portfolio bid.

At operation 1620 it can be determined whether or not any bids have monetary value. If one or more bids have monetary value, at operation 1622, the order in which bidders receive the item is established according to the monetary values or their respective bids. At operation 1624, all monetary and non-monetary bids are rank ordered, with the bids having higher monetary values receiving the item before the nonmonetary bids (which are first bid first ranked), and the transaction commences. At operation 1626, the transaction is completed when the last bidder (whether or not a portfolio bidder) receives the item. The last person to receive the item may be the default docker bidder coming in possession of the item until the item is transferred to the next bid transaction. At operation 1628, the docker bidder may possess the item for a predetermined period of time until the item is automatically posted for sale again after the expiration of the predetermined period of time. In some example embodiments, at operation 1630, the seller may have an option of regaining the item from the docker bidder.

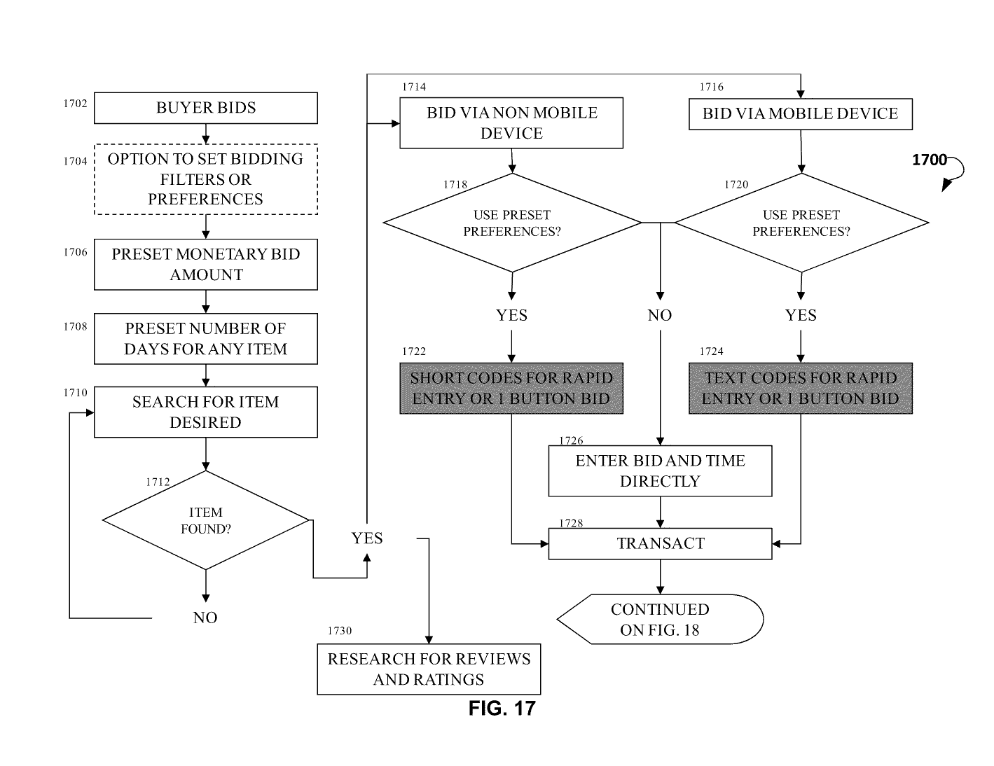

FIG. 17 is a flow chart showing a method 1700 for combinatorial portfolio aggregations in electronic utilizing various interface devices, in accordance with an example embodiment. Bidders can bid using many forms of user interface devices. Hot keys can assist them in making a bid with one or more keys or words. The method 1700 may commence with a buyer starting the bidding process at operation 1702. Prior to placing the bid, the buyer may have an option of setting bidding filters or preferences at operation 1704. For example, the buyer may wish to first view the items placed by sellers in his or her friends. At operation 1706, the buyer may preset desired monetary bid amounts for the items available for bidding. At operation 1708, the buyer may preset the time limit a desired sale item is on sale and at operation 1710, the buyer may search for the desired item based on the foregoing parameters.

At decision block 1712, it can be determined whether or not the desired item is available. If the desired item is not found, the buyer can repeat the search at operation 1710. If, on the other hand, the item is found and the bid placed via a non-mobile device (as determined at operation 1714), the method 1700 may proceed to decision block 1718, where it can be determined whether or not preferences associated with the non-mobile device can be used. If it is determined that the preferences can be used, short codes for rapid entry or a one button bid can be used to place the bid at operation 1722. The transaction then can take place at operation 1728.

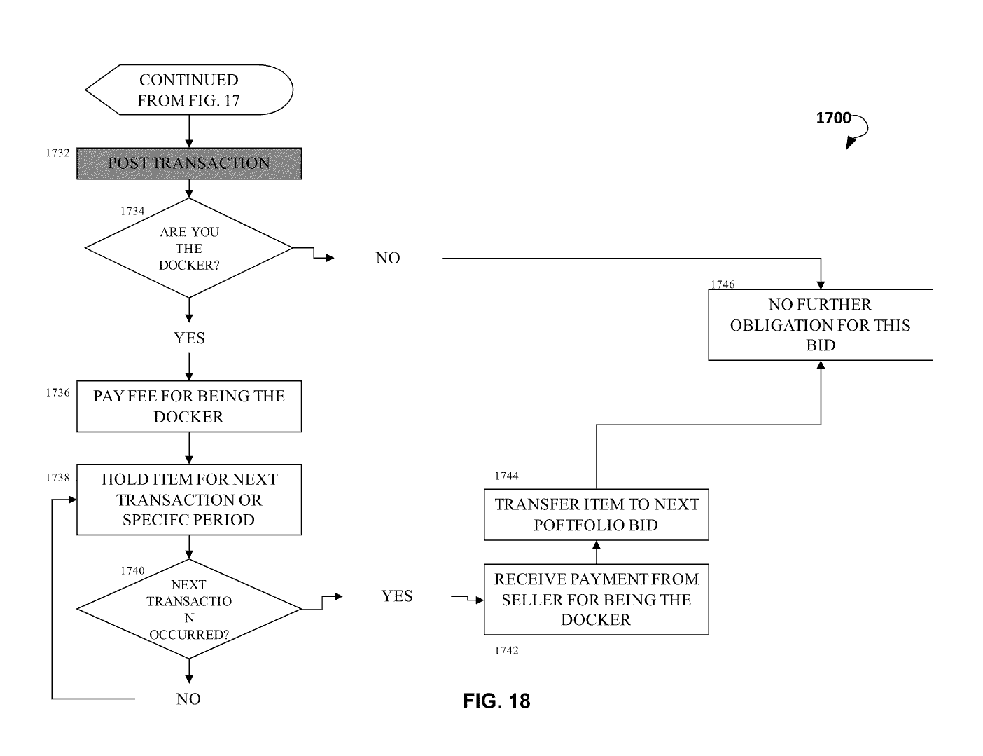

If the buyer is using a mobile device (as determined at operation 1716), the method 1700 may proceed to operation 1720, where it can be determined whether or not preferences associated with the mobile device can be used. If it is determined that the preferences can be used, text codes for rapid entry or a one button bid can be used to place the bid at operation 1724. The transaction then can take place at operation 1728. If on the other hand it is determined at decision blocks 1718 or 1720 that the preset preferences cannot be used, the method 1700 may proceed to operation 1726, where the user can manually enter the bid and time. The method 1700 may then proceed to operation 1732 in FIG. 18.

FIG. 18 is a flow chart showing the method 1700 for combinatorial portfolio aggregations in electronic trade using a docker bidder, in accordance with an example embodiment. At operation 1732, the transaction is completed (post meaning the end of the transaction). If it is determined at decision block 1734 that the bidder is a docker bidder, the bidder may pay a fee for being a docker bidder at operation 1736. At operation 1738, the item may be held until another transaction transfers the item or for a predetermined period of time. If, at decision block 1740, it is determined that the next transaction has occurred, the seller may pay the docker bidder at operation 1742, and the item is transferred to the next portfolio bid at operation 1744. As shown at operation 1746, no further obligations for this bid incur once the item is transferred. Furthermore, if the next transaction does not occur at operation 1740, the item is held by the docker at operation 1738. Similarly, if it is determined at operation 1734 that the bidder is not a docker bidder no further obligations by the bidder incur at operation 1746.

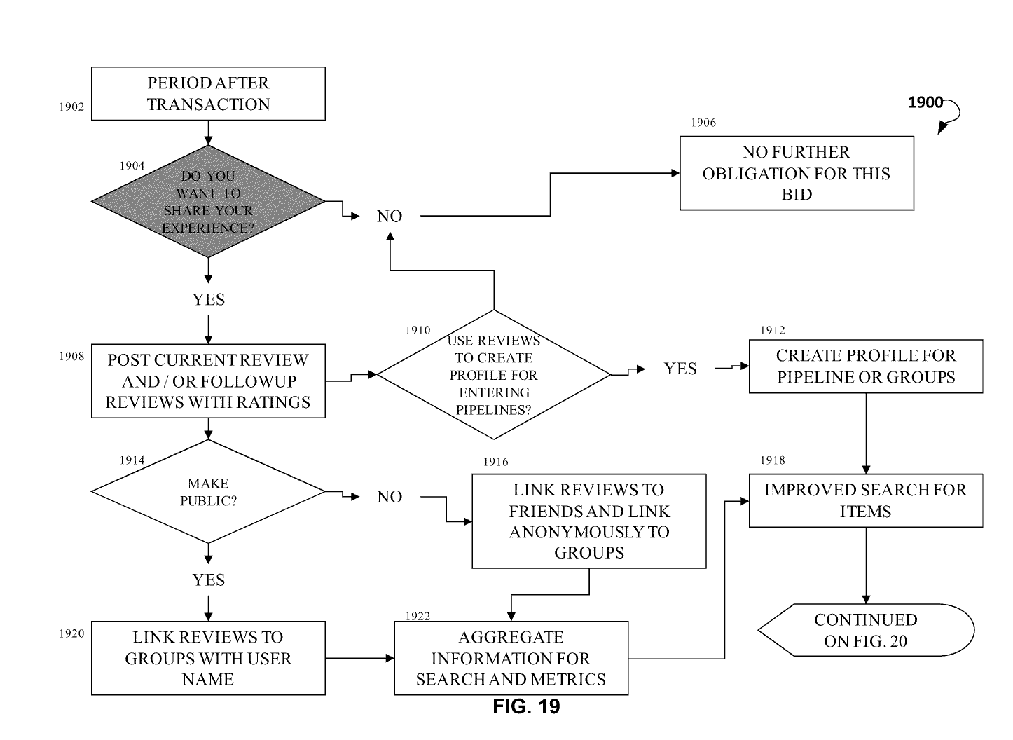

FIG. 19 is a flow chart showing a method 1900 for combinatorial portfolio aggregations in electronic trade utilizing friend attributes, in accordance with an example embodiment. The method 1900 may commence at operation 1902 after the transaction has completed. At decision block 1904, it can be determined whether or not a party to the transaction wishes to share his or her experience. If the party does not wish to share his or her experience, no further obligations incur, as shown at operation 1906. If, on the other hand, the party wishes to share their experiences, he or she may post a current review or follow up reviews with ratings at operation 1908. If the review can be used to create a profile for entering pipelines, as determined at decision block 1910, the profile can be created at operation 1912, resulting in an improved search for items at operation 1918 for the individual bidder. If it is determined at operation 1910 that the reviews are not to be used to create a profile for entering pipelines, no further obligation is incurred as shown at operation 1906.

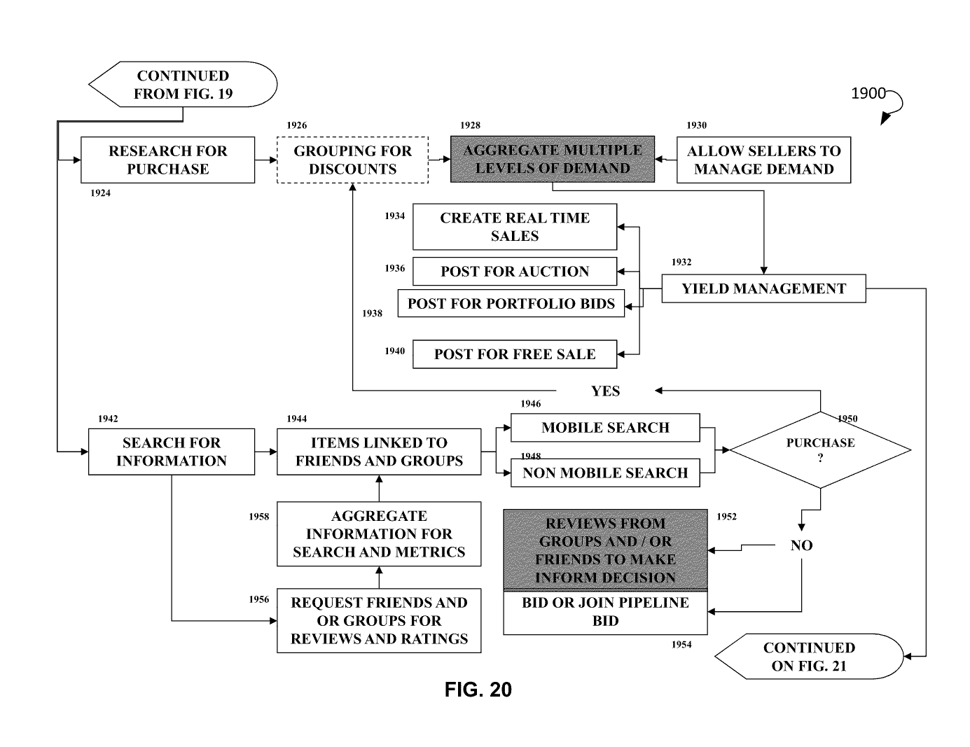

At decision block 1914, it can be determined whether or not the reviews can be made public. If the reviews can be made public, the reviews may be linked at operation 1920 to the groups associated with the bidder being reviewed, and the information may be aggregated with other data associated with the group metrics at operation 1922, which consequently results in improved search for the item at operation 1918. If the reviews cannot be made public, the information can be available to friends at operation 1916, but will remain linked anonymously to groups of users. A bidder can be linked by friends so that they may be notified of their friends' ratings and comments first, in addition to public ratings. This may provide a deeper level of information for the bidder when deciding whether to place a bid and the bid amount. Searches can be done based on friends, items, description, or item identification. Once the aggregate information based on individual reviews results in improved search for items, the method 1900 may continue to operation 1924 in FIG. 20.

FIG. 20 is a flow chart showing the method 1900 for combinatorial portfolio aggregations in electronic trade utilizing friends and various trade channels, in accordance with an example embodiment. From operation 1918 shown on Figure, the method 1900 may proceed to operation 1924 or operation 1942. In either case, the method enables buyers to record their search information, so that they can make better decisions. The difference between operations 1924 and 1942 is that at operation 1924, a buyer searches for an item in order to make an immediate purchase, and at operation 1942, the buyer merely browses available offerings in order to gather information.

Accordingly, if the method 1900 follows the path of operation 1926, the buyers may be willing to group their orders at 1926 as there may be other users searching for items under using the same criteria. Based on these groupings, multiple levels of demand may be aggregated at operation 1928. The demand may be aggregated by how much the buyers are willing to pay, how long they want to use it, and what specific item they want to use. Discounts applied to this aggregated demand may depend on the number of buyers, how long the buyers want to possess the item and so forth.

At operation 1930, the seller may review the aggregated demand created by the sellers and decide how to manage that demand. A marketing module can be implemented where promotional codes are given out and bidders need to enter the codes on the site. However, unlike traditional promotions, these promotions may reserve the promotional benefits over a period of time after entry instead of only at checkout for one time. For example, enter your promotional code WE34E by Oct. 10, 2010 and continue receiving discounts/rewards for the next 3 months. Thus, at operation 1928 interests of both sellers and the buyers may come together. If, for example, there are 10 buyers wishing to buy a PlayStation 4, the 10 buyers may be formed in a group because everyone wants a PlayStation 4. The aggregated price, which the 10 buyers are willing to pay for the PlayStation 4 can be determined by aggregating the prices each individual buyer is willing to pay and matching the time periods for which they are willing to possess the PlayStation 4. For, example the total value may be $100. The seller, on the other hand, may be willing to sell a PlayStation 4 for $50.

At this point, the buyers have not necessarily formed a portfolio offer, they are just searching an item based on certain criteria. Thus, at operation 1928, the buyers can be assembled together, based on based on their demand. Once the demand is known, the method 1900 may proceed to operation 1932 at which the seller may decide how he wants to manage the demand. The seller may be willing to sell the item at operation 1934 based on the current demand and make a real time sale. Alternatively, the seller may inform the buyers at operation 1936 that he is putting the item up for auction inviting the buyers to bid on the item.

Furthermore, at operation 1938, the item can be posted for portfolio bids allowing users to bid collectively within the bid aggregation model. If the buyer wants to give the item away free of charge, with the purpose of promotion for example, at operation 1940, the buyer may allow buyers to bid zero. Thus, sellers may have several options in managing the buyer demand.

If, instead of searching for an immediate purchase, the buyer decides to perform a market research at operation 1942, he or she can do so by invoking comments made by his or her friends. Going back to the FIG. 19, buyers were allowed to leave comments regarding their transactions. Comments can be left by anonymous buyers or by buyers stating their names. Having a name associated with a comment may make that provide the comment with more weight, especially if the buyer searching for information is associated with the buyer who has made the comment. In addition, feedback can be private, only visible to a certain group of people, for example, friends. A way for buyers to associate as friends is to have been put together in a portfolio bid. Thus, buyer may have an option of staying connected as friends because they have transacted together in the past. Another way to associate with friends is to form a group. Buyers can associate based on a common interest, for example, collectors of coins in addition to other ways groups can be formed.

At operation 1944, the item that the buyer is looking for may be associated with his or her record and groups. Thus, if the buyer is looking for a specific item, he or she may see the comments made by private friends. Thus, the method 1900 may be linking buyers to product instead of linking products to buyers. If, instead, the buyer make request of a friend at operation 1956, the information may be aggregated in a readable format at operation 1958 and shown to the buyer at operation 1944. Depending on whether the buyer is, performing mobile or non-mobile search the method 1900 may proceed to operations 1946 and 1948, respectively. For example, a potential buyer may walk into a Wal-Mart and get a wireless device to perform a search. After the buyer receives the information, he/she can make a decision at 1950. If he decides to purchase, the method 1900 may continue to operation 1926 where he can be associated with other buyers. If, instead he decides to continue his search at operation 1952. Alternatively, the buyer can bide or join a pipeline bide at operation 1954.

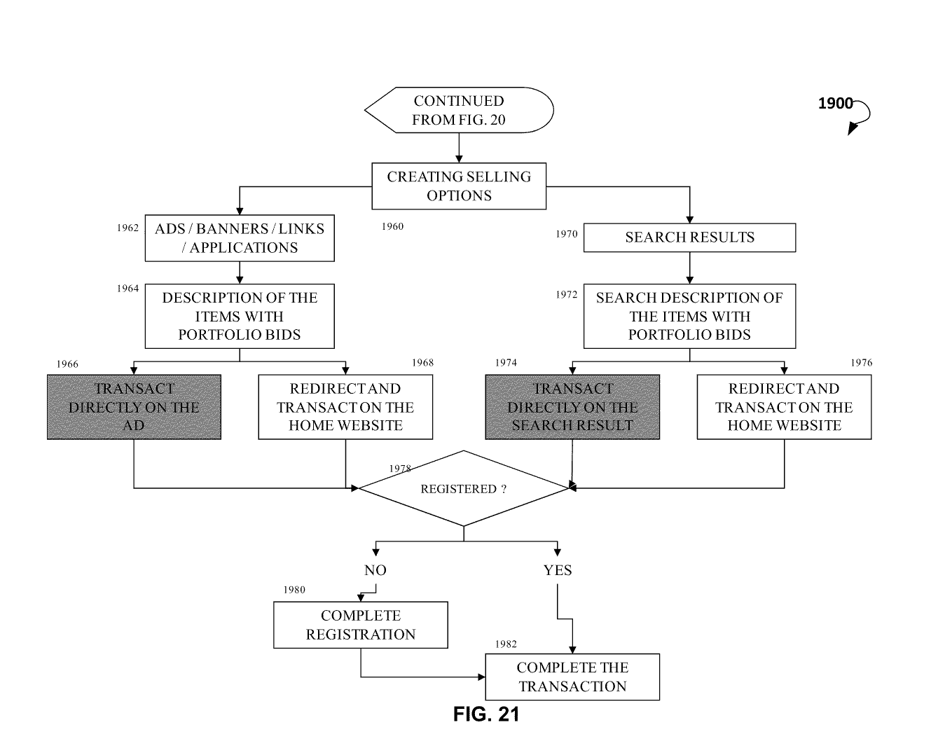

FIG. 21 is a flow chart showing the method 1900 for combinatorial portfolio aggregations in electronic trade utilizing various trade channels, in accordance with an example embodiment. Sellers may have various channels to make a sale. They can sell to one buyer for one price, a group of buyers for another price, one buyer for an auction price, or all buyers without a price. Sellers can reach buyers by advertisement, banners, links, mobile applications or search results. Within each channel, sellers can provide information only or allow buyers to bid and transact immediately within the advertisements, banners, links, mobile applications, or search results. Additionally, sellers may transact through the redirected link. The cost to sellers may vary based on current conventional advertisement costs or based on sales. Sellers can create discounts, group discounts, or give the item out for free to attract buyers.

At operation 1960, selling options can be created. At operation 1962, advertisements, banners, links, or applications can be associated with the sale. The description of the items with portfolio bids can be created at operation 1964. If the buyer clicks on an advertisement, a transaction can be performed directly within the advertisement, as shown at operation 1966, or the buyer can be redirected and the transaction performed on the home website of the advertiser, at operation 1968. Alternatively, instead of proceeding to operation 1962, the method 1900 may proceed to search results at operation 1970 and then to search description of the items with portfolio bids at operation 1972, and either transact directly on the search result at operation 1974 or be redirected to the home website of the seller associated with the search result at operation 1976.

Before the transaction can be completed, it may be determined at decision block 1978 whether or not the buyer is registered. If it is determined that the buyer is registered, the transaction can be completed at operation 1982. Otherwise, the registration can be first completed at operation 1980 before the transaction is completed at operation 1982.

Thus, methods and systems for combinatorial portfolio aggregations in electronic trade have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

1. A computer-implemented method, the method comprising:
receiving data associated with an offer for possession of at least one part of an item for a period of time, the item being associated with item properties and item transfer criteria;
receiving further data associated with at least one further offer for possession of the at least one part of the item for at least one further period of time, the time period and the at least one further period of time being non-concurrent;
matching the offer to the item based on the data associated with the offer for possession, the item properties, and the item transfer criteria;
based on the matching, selectively aggregating the offer with the at least one further offer into a portfolio offer for the at least one part of the item; and
based on predetermined criteria, determining that the portfolio offer is a winning portfolio offer.

2. The computer-implemented method of claim 1, further comprising a queue of pipeline including one or more bids that are rejected or lost, the wherein the queue of pipeline offers consists of a plurality of offers for items having predetermined similarities.

3. The computer-implemented method of claim 2, wherein a seller associated with the offer has one or more following options with respect to the at least one part of an item: selling, continual lease, repossession after a trade, lowering a sales price, the continual lease being via a docker and no ownership bids and the repossession occurring after a trade if the sales price is not met or the seller wants to share the at least one part of an item.

4. The computer-implemented method of claim 3, wherein a buyer requests the offer to be placed in the queue of pipeline offers after the offer fails to become a part of a separate winning portfolio offer.

5. The computer-implemented method of claim 1, further comprising enabling a docker offer for the at least one part of the item, the docker offer being for the possession of the at least one part of the item until another offer is placed, provided that there is no offer for an ownership of the at least one part of an item or the ownership is not allowed.

6. The computer-implemented method of claim 1, wherein the offer is placed via one of a plurality of user interface devices using one or more hot keys, the hot keys being short cuts that a bidder predefines and uses in a bid.

7. The computer-implemented method of claim 1, wherein the offer is influenced by feedback associated with one or more friends, the feedback being information provided by the one or more friends, the one or more friends being one or more of the following: a person currently or previously grouped with the bidder, a person previously or currently transacting with the bidder, a person sharing a common interest with the bidder.

8. The computer-implemented method of claim 1, wherein the offer is placed via one or more channels of trade, the channels of trade including one or more of the following actionable advertisements: a banner, a link, a mobile application, a mobile advertisement, an electronic marketing campaign, and a search result, a bidder being able to place a bid directly within the actionable advertisements.

9. A computer-implemented method, the method comprising:
receiving data associated with an offer for possession of at least one part of an item for a period of time;
receiving further data associated with at least one further offer for possession of the at least one part of the item for at least one further period of time, the time period and the at least one further period of time being non-concurrent;
selectively aggregating the offer with the at least one further offer into a portfolio offer for the at least one part of the item;
based on predetermined criteria, determining that the portfolio offer is a winning portfolio offer;
determining whether an escrow amount is required; and
based on the determination, requiring payment of an escrow to take the possession of the item.

10. The computer-implemented method of claim 9, wherein the escrow is paid by each non-owner buyer associated with the portfolio offer before a first transfer occurs.

11. The computer-implemented method of claim 10, wherein the escrow is released after a last transfer occurs.

12. The computer-implemented method of claim 9, wherein the escrow is paid by each non-owner buyer associated with the portfolio offer before a transfer to the non-owner buyer occurs.

13. The computer-implemented method of claim 9, wherein the escrow is released after the transfer is verified by a next buyer.

14. The computer-implemented method of claim 9, further comprising a marketing module, the marketing module enabling providing promotional codes to one or more bidders, the promotional codes reserving promotional benefits over a period of time.

15. A computer-implemented method, the method comprising:
receiving data associated with an offer for possession of at least one part of an item for a period of time, wherein the possession is for demonstration purposes and the at least one part of the item being offered so that one or more bidders experience the at least one part of an item, the one or more bidders placing a docker bid or a nonmonetary bid, the at least one part of an item being continuously posted and reposted;
receiving further data associated with at least one further offer for possession of the at least one part of the item for at least one further period of time, the time period and the at least one further period of time being non-concurrent;
selectively aggregating the offer with the at least one further offer into a portfolio offer for the at least one part of the item; and
based on predetermined criteria, determining that the portfolio offer is a winning portfolio offer.

16. The computer-implemented method of claim 15, wherein a seller or an owner buyer associated with the offer sets one or more of the following: a maximum total demo period, a maximum individual demo period, a quantity of demo items.

17. The computer-implemented method of claim 16, wherein the offer and the at least one further offer include a non-monetary offer.

18. The computer-implemented method of claim 15, wherein the item is transferred after a predetermined initial period.

19. The computer-implemented method of claim 15, wherein each buyer associated with the winning portfolio offer is to fill out a survey, a feedback, or a review regarding the item after a demonstration period has concluded.

20. The computer-implemented method of claim 15, wherein the item is returned to the seller or the owner buyer after the demo is concluded.
